(19) United States
(12) Patent Application Publication
(10) Pub. No.: US 2026/0172751 A1
(43) Pub. Date: Jun. 18, 2026

(54) METHOD, DEVICE, AND SYSTEM FOR GENERATING A CORRECTED AUDIO SIGNAL

(71) Applicant: Y.E. Hub Armenia LLC, Yerevan (AM)

(72) Inventor: Oleg KORTEV, Moscow (RU)

(21) Appl. No.: 19/260,395

(22) Filed: Jul. 4, 2025

(30) Foreign Application Priority Data
Dec. 18, 2024 (RU) 2024138330

(51) Int. Cl. H04R 3/04; H04R 29/00

(52) U.S. Cl. CPC H04R 3/04; H04R 29/001; H04R 2430/01

(57) ABSTRACT

An audio signal distortion compensation system is disclosed. The distortion compensation system comprises a pre-distortion core (which may be a processor or a plurality of processors) configured to generate a position value together with a speed value of the diaphragm of the loudspeaker driver, and use the position value, the speed value, and a value of an input audio signal of the pre-distortion core to generate a corrected audio signal with a corrected audio value. The corrected audio value is sent to the loudspeaker driver to mitigate vibrations of the loudspeaker driver.

### CROSS-REFERENCE

This application claims priority to Russian Patent Application No. 2024138330, entitled “Method, Device, and System for Generating a Corrected Audio Signal”, filed on Dec. 18, 2024, which is hereby incorporated by reference in its entirety.

### TECHNICAL FIELD

The present technology relates generally to loudspeakers and acoustic characteristics thereof, and more specifically to methods, devices, and systems to generate a corrected audio signal.

### BACKGROUND

The present technology generally relates to smart audio devices, smart audio systems, and methods to operate the smart audio devices and systems. More specifically, embodiments of the technology apply to smart audio devices and systems, comprising both microphones and loudspeakers, and methods to determine and mitigate noises and vibrations in the loudspeakers. Smart audio devices and systems may in addition control cameras, doorbells, locks, thermostats, plugs and outlets, lighting, and more.

A loudspeaker (also, referred to herein as a “loudspeaker device”) is a device including an enclosure and drive units capable of converting an electrical audio signal into a respective sound.

When manufacturing the loudspeaker, its quality may typically be assessed by certain acoustic characteristics indicative of user experience in respect of the sound produced thereby. Such acoustic characteristics may include, for example, consistency of a frequency response associated with the loudspeaker and its resonance frequencies. Generally speaking, the former is indicative of a capability of the loudspeaker to maintain constant amplitude of the audio signal within an operating frequency range of the loudspeaker. In the mean time, one of the resonance frequencies may be associated with a width of the operating frequency range of the loudspeaker defining a lower boundary thereof, as it may be experimentally demonstrated that, at a frequency lower than the resonance frequency, the amplitude may significantly drop (for example, by 12 dB per octave), which may cause distortions to the produced sound recognizable by the ear.

Typically, the operating frequency range of the loudspeaker may be defined by a plurality of drive units of the loudspeaker respectively configured to operate within predetermined frequency subranges, such as: a bass frequency subrange (from around 20 Hz to around 320 Hz), a midrange frequency subrange (from around 320 Hz to around 1280 Hz), and a treble frequency subrange (from around 1280 Hz to around 20400 Hz)—covering the sound range of the human hearing.

Smart loudspeaker devices have been recently introduced on the market. The manufacturers of the smart loudspeaker devices have been challenged with finding a balance between the size of the smart loudspeaker device and acoustic quality of the sound produced by such smart loudspeaker devices.

Proposed solutions to tackle the above-identified technical problems include a passive radiator and a conical diffusor. However, these solutions have proven to be ineffective.

Therefore, there is a need for methods, devices, and systems for nonlinear audio signal distortion compensation that obviate or mitigate one or more limitations of the prior art.

### SUMMARY

When reducing a size of the enclosure of the loudspeaker, for example, to improve the ergonomics thereof, only a single wide-range drive unit may be used. This may consequently cause high values of the resonance frequency associated with the loudspeaker—for example, around 200 to 250 Hz, thereby shortening the operating frequency range of the loudspeaker.

When operated to playback, loudspeaker drivers and other electro-acoustical transducers along with other mechanical structures and components may generate vibrations. During operation, loudspeakers of a smart audio device may be affected by other acoustic and electro-magnetic components the smart audio device, for example, a first loudspeaker (low frequencies bass) may affect a second loudspeaker (high frequencies “twitters”), and so on.

Vibrations of the loudspeakers are non-linear due to the electro-acoustical nature of the loudspeakers. Nonlinear nature of the vibrations may also come from the nonlinear variation of the voltage applied to the loudspeakers. The vibrations are causing distortion of the final audio spectrum as perceived by a listener. The vibrations may also affect other components of the smart audio devices. For example, a microphone of a smart audio device may receive more noise and therefore shows worse user voice detection quality.

Nonlinear vibrations of loudspeakers may be mitigated and compensated mechanically by using better quality materials, including noise cancelling materials, by increase separation between the loudspeakers, by employing smaller loudspeaker drivers, etc. Mechanical and component arrangements are limited by required device size, overall mass, etc.

Another way to mitigate and compensate nonlinear vibrations in loudspeakers is based on generation of compensation signals. An input audio signal together with a compensation signal may be used to generate a corrected input audio signal. The key challenge in generating a compensation signal is the nonlinear nature of the vibrations which makes it difficult to predict the vibrations and hence generate a quality compensation signal.

Non limiting embodiments of the present disclosure are directed to loudspeakers and acoustic characteristics thereof, and more specifically to methods, devices, and systems to generate a corrected audio signal.

According to embodiments of the present invention, there is provided a method for generating a corrected audio value for a loudspeaker driver. The method executable by one or more processors. The method includes (at a given moment in time) receiving an input audio value of an input audio signal, generating a position value for a diaphragm of the loudspeaker driver. The position value being indicative of a predicted displacement of the diaphragm at or following receipt of the input audio value. The method further includes generating a speed value for the diaphragm, the speed value being indicative of a predicted speed of the diaphragm at or following receipt of the input audio value, generating a corrected audio value using the input audio value, the position value, and the speed value, and sending the corrected audio value to the loudspeaker driver for mitigating vibrations of the loudspeaker driver. In some embodiments, the method may further include storing the corrected audio value to a buffer. In some embodiments, generating the position value may be done using a Neural Network (NN), where a plurality of previous audio values is inputted to the NN, the plurality of previous audio values is stored in a buffer. In some embodiments, prior the given moment in time, the NN is trained using a training set to predict displacement of the diaphragm of the loudspeaker driver at or following receipt of the input audio value. The training set includes one or more elements, each element is associated with a respective voltage drop across a test loudspeaker driver and a value of a displacement of a diaphragm of the test loudspeaker driver caused by the respective voltage drop.

In some embodiments of the method, the plurality of previous audio values comprises at least one of a previous input audio value and a previous corrected audio value, the previous input audio value being a preceding input audio value to the input audio value in the input audio signal, and the previous corrected audio value having been generated prior to the given moment in time. In some other embodiments of the method the plurality of previous audio values comprises about 750 audio values. In some other embodiments of the disclosed method, generating the speed value comprises generating the speed value using the position value and a plurality of previous position values, the plurality of previous position values having been generated prior to the given moment in time wherein the generating the speed value comprises applying a spline interpolation function on the position value and the plurality of previous position values. In some embodiments, the plurality of previous position values comprises about 20 previous position values. In some other embodiments of the method, the input audio signal has a frequency range between about 20 and 200 Hz, and/or the buffer is a First-In-First-Out (FIFO) buffer.

According to embodiments of the present invention, there is provided a processor for generating a corrected audio value for a loudspeaker driver, the processor is configured to, at a given moment in time, receive an input audio value of an input audio signal, generate a position value for a diaphragm of the loudspeaker driver, the position value being indicative of a predicted displacement of the diaphragm at or following receipt of the input audio value, generate a speed value for the diaphragm, the speed value being indicative of a predicted speed of the diaphragm at or following receipt of the input audio value, generate a corrected audio value using the input audio value, the position value, and the speed value, and send the corrected audio value to the loudspeaker driver for mitigating vibrations of the loudspeaker driver. In some embodiments of the processor, the position value being generated using a plurality of previous audio values stored in a buffer, and the plurality of previous audio values being inputted to a Neural Network (NN). In some embodiments, prior the given moment in time, the NN having been trained using a training set to predict displacement of the diaphragm of the loudspeaker driver at or following receipt of the input audio value, the training set including one or more elements, each element is associated with a respective voltage drop across a test loudspeaker driver and a value of a displacement of a diaphragm of the test loudspeaker driver caused by the respective voltage drop. In some embodiments of the processor, the plurality of previous audio values comprises at least one of a previous input audio value and a previous corrected audio value, the previous input audio value being a preceding input audio value to the input audio value in the input audio signal, and the previous corrected audio value having been generated prior to the given moment in time. In some embodiments of the processor, the plurality of previous audio values comprises about 750 audio values, and/or the buffer is a First-In-First-Out (FIFO) buffer. In some other embodiments of the processor the speed value being generated by applying a spline interpolation function on the position value and the plurality of previous position values. In other embodiments of the processor, the plurality of previous position values comprises about 20 previous position values.

In some embodiments of the processor, the speed value being based on the position value and a plurality of previous position values, the plurality of previous position values having been generated prior to the given moment in time, in some other embodiments, the input audio signal has a frequency range between about 20 and 200 Hz.

A system according to embodiments includes a processor for generating a corrected audio value for a loudspeaker driver.

For purposes of this application, terms related to spatial orientation, such as forwardly, rearwardly, upwardly, downwardly, left, right, and the like, are as they would normally be understood by a user or operator of the device. Terms related to spatial orientation when describing or referring to components or sub-assemblies of the device, separately from the device should be understood as they would be understood when these components or sub-assemblies are mounted to the device.

Further, it should be expressly understood that the terms related to the spatial orientation listed above should be interpreted, in the context of the present specification, as depicted in the provided drawings.

Implementations of the present technology each have at least one of the above-mentioned aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top perspective view of a speaker device, in accordance with certain non-limiting embodiments of the present technology.

FIG. 2 is a partially exploded perspective view, taken from a top of the speaker device of FIG. 1 depicting an acoustic assembly housed therewithin, in accordance with certain non-limiting embodiments of the present technology.

FIG. 3 is a side elevation view and a vertical cross-sectional view of the loudspeaker device of FIG. 1, in accordance with certain non-limiting embodiments of the present technology.

FIG. 4 is a top planar view of the loudspeaker device of FIG. 2, in accordance with certain non-limiting embodiments of the present technology.

FIG. 5 depicts an example of a diagram of a frequency response to a given sound produced by the loudspeaker device of FIG. 2, in accordance with certain non-limiting embodiments of the present technology.

FIG. 6 illustrates the block diagram of loudspeaker driver 118 under the test.

FIG. 7 illustrates the cross-sectional view of loudspeaker driver 118.

FIG. 8 illustrates the electric current inputted to loudspeaker 118 in the time domain.

FIGS. 9-11 illustrate the normalized flux linkage coefficient b(x)/b(xo) as a plurality of experimental estimates, an approximated function, and the adjusted approximated function, respectively.

FIG. 12 illustrates relationship between the coefficient of elasticity dependency and the displacement of diaphragm 212.

FIG. 13 illustrates the voltage drop across loudspeaker driver 118 in the time domain.

FIG. 14 illustrates the approximated impedance of loudspeaker driver 118 under the test.

FIG. 15 shows an example of I_{AC} in the frequency domain.

FIG. 16 illustrates the impedance of loudspeaker driver 118 measured by the OFDM method.

FIGS. 17 and 18 illustrate the OFDM measured voltage drop across loudspeaker driver 118 with coherent subcarriers and randomly selected subcarriers, respectively.

FIG. 19 illustrates a diagram of the OFDM measurement procedure.

FIG. 20 illustrates a flowchart for evaluation of k(x) and b(x) of the loudspeaker driver model.

FIG. 21A illustrates a block-diagram of the distortion compensation unit.

FIG. 21B illustrates a method to generate by one or more processors a corrected audio value for a loudspeaker driver.

FIG. 22 illustrates the distortion compensation unit with the booster unit.

FIG. 23 illustrates the gain function of the amplifier.

FIG. 24 illustrates the phase transfer function of the amplifier.

FIG. 25 illustrates an architecture of the neural network.

FIG. 26 illustrates the total harmonic distortion of the sound before and after application of the distortion compensation unit.

FIG. 27 illustrates the amplitude of the third harmonic as a percentage of the amplitude of the fundamental tone.

FIG. 28 illustrates the amplitude of the second harmonic as a percentage of the amplitude of the fundamental tone.

FIG. 29 illustrates the amplitude of the signal before and after application of the technology in the time domain.

FIG. 30 illustrates fast Fourier transform (FFT) of the signal before and after application of the technology.

FIGS. 31-32 illustrate efficient suppression of the harmonics of the bass tones in the range between 200 and 500 Hz.

FIG. 33 illustrates dB SPL of the fundamental tone before and after application of the technology.

### DETAILED DESCRIPTION

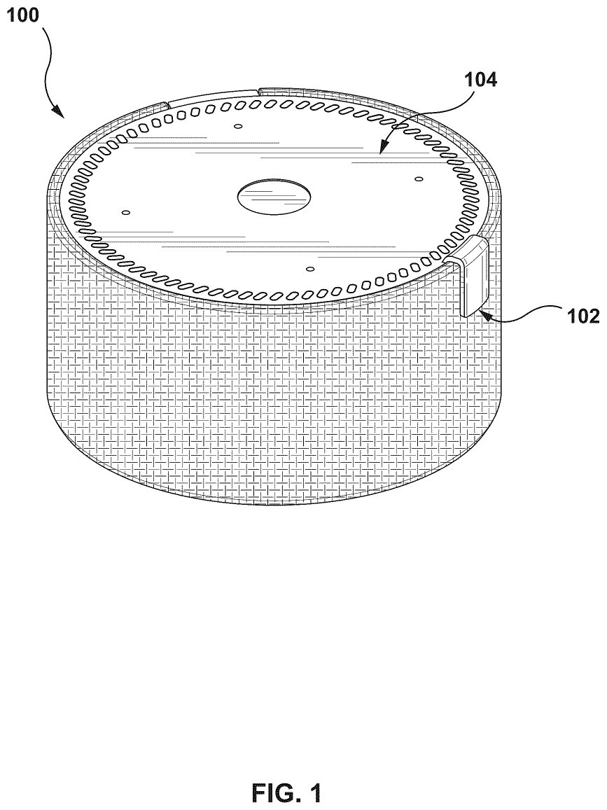

Referring initially to FIGS. 1, there is depicted a loudspeaker device 100, in accordance with certain non-limiting of the present technology. The speaker device 100 can be positioned by an operator (not depicted) thereof on a flat support surface, such as a desk (not depicted), for example. The loudspeaker device 100 may be configured to convert electrical signals into respective sounds within a predetermined audio spectrum. For example, the loudspeaker device 100 may be configured to reproduce songs and/or other audio feeds, which the operator of the loudspeaker device 100 wishes to hear. In additional non-limiting embodiments of the present technology, the loudspeaker device 100 may be configured to reproduce the respective sounds in response to predetermined spoken utterances and/or haptic interactions of the operator of the loudspeaker device 100.

In certain non-limiting embodiments of the present technology, the predetermined audio spectrum associated with the loudspeaker device 100 may correspond to a range appreciable by a human ear. In these embodiments, the predetermined audio spectrum may cover a range of electromagnetic radiation having frequency between around 100 Hz and around 20000 Hz. In this regard, according to certain non-limiting embodiments of the present technology, the predetermined audio spectrum may include: (1) a low range from around 100 Hz to around 320 Hz (also referred to herein as a “bass frequency range”); (2) a middle frequency range from around 320 Hz to around 1280 Hz (also referred to herein as a “mid-frequency range”); and (3) a high range from around 1280 Hz to around 20400 Hz (also referred to herein as a “treble frequency range”). Further, each one of the low range, the middle range, and the high range may additionally be subdivided into a lower subrange, a middle subrange, and an upper subrange. For example, the low range may thus be represented as a combination of a low-bass subrange, a middle-bass subrange, and an upper-bass subrange. How the loudspeaker device 100 is configured to reproduce a given sound within the predetermined audio spectrum will be described herein below.

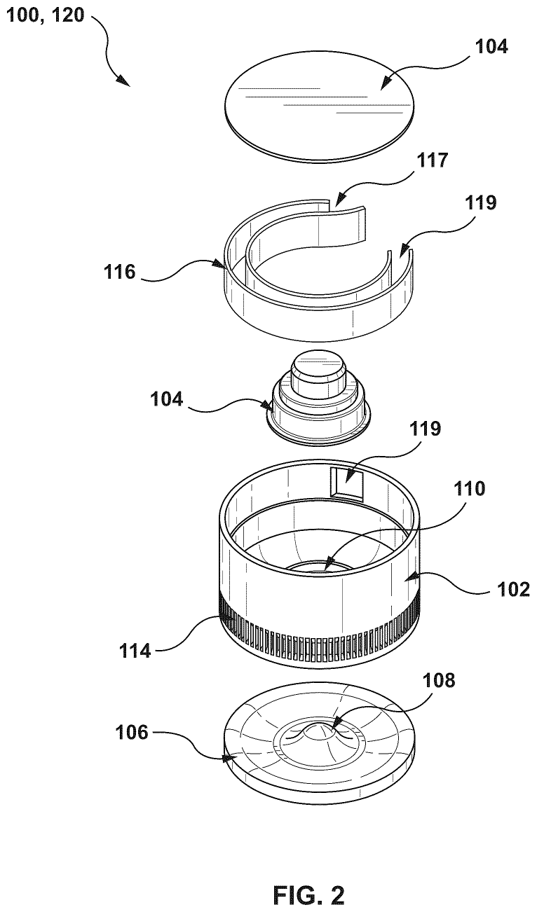

In certain non-limiting embodiments of the present technology, the loudspeaker device 100 may be configured to operate within the predetermined audio spectrum using a specifically configured acoustic assembly, such as an acoustic assembly 120 as depicted in FIG. 2, in accordance with certain non-limiting embodiments of the present technology, components of which will be described below.

With reference to FIGS. 1 and 2, the loudspeaker device 100 includes a housing further including a side surface 102 configured for receiving a top assembly 104 and a bottom assembly 106.

In some non-limiting embodiments of the present technology, the housing of the loudspeaker device 100 is a compact housing having its largest dimension not exceeding 100 mm.

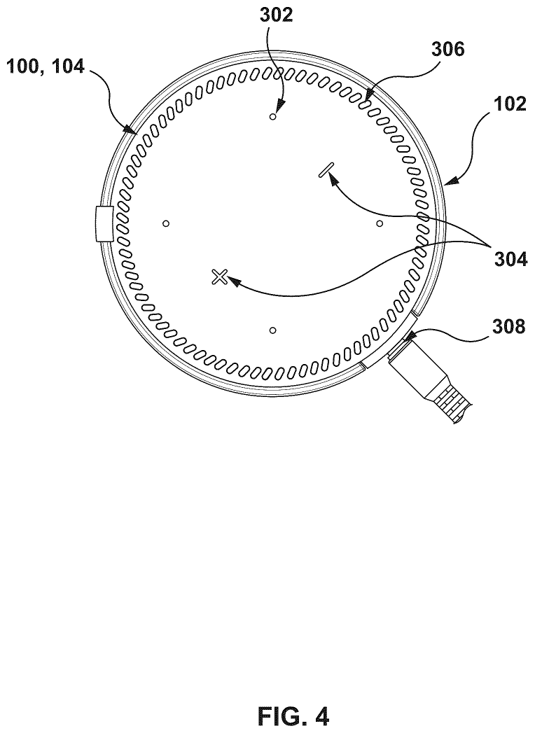

FIG. 4 illustrates another non-limiting embodiment of the present technology. In this embodiment the top assembly 104 may be configured for (i) receiving commands from the operator (not depicted) of the loudspeaker device 100; and (ii) providing visual indications to the operator. In some non-limiting embodiments of the present technology, the top assembly 104 may include a plurality of various apertures, including, for example, LED apertures 302 configured for receiving respective LED light sources. Further, the top assembly 104 may further include buttons, such as sensor buttons 304 configured for modulating an amplitude of the given sound produced by the loudspeaker device 100, as an example.

Finally, according to certain non-limiting embodiments of the present technology, the top assembly 104 may further define a plurality of acoustic openings 306 configured for conducting the given sound produced by the loudspeaker device 100 within the outside environment thereof. The plurality of acoustic openings 306 may vary in shape and number suitable for providing smooth distribution of the sound waves associated with the given sound within the outside environment. For example, and not as a limitation, the plurality of acoustic openings 306 may be defined along an outline of the top assembly 104 in a circular fashion, as depicted in FIG. 4.

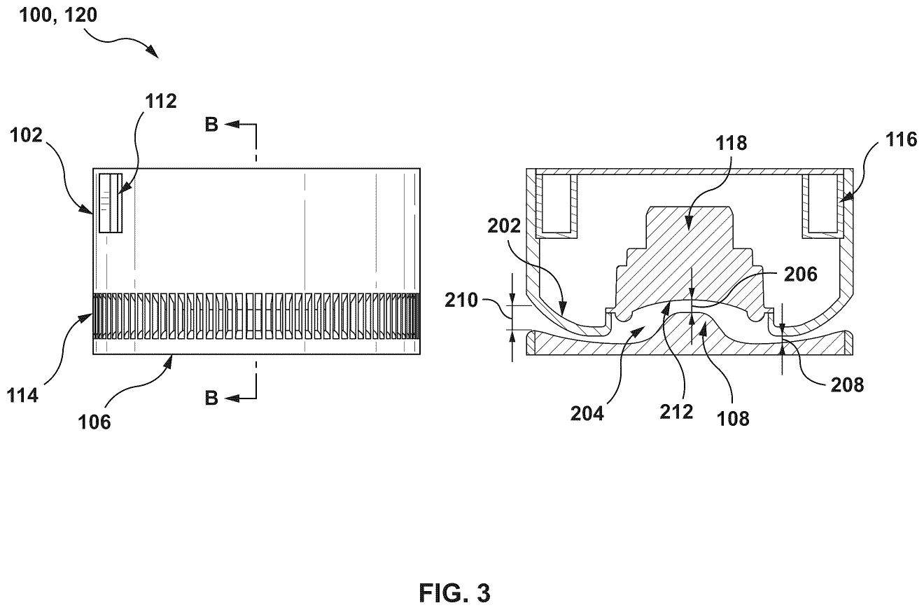

Further, referring to FIGS. 2 and 3, according to certain non-limiting embodiments of the present technology, the side surface 102 may be of a cylindrical form configured for receiving the top assembly 104 and the bottom assembly 106, such that, when the loudspeaker device 100 is assembled, the top assembly 104 and the bottom assembly 106 are flush levelled with a top and a bottom of the side surface 102, respectively.

According to certain non-limiting embodiments of the present technology, the side surface 102 may define a loudspeaker grid 114. As depicted in FIG. 2, the loudspeaker grid 114 may be defined around the side surface 102 in an annular form (however, other form factors are envisioned) parallel to one of the top assembly 104 and the bottom assembly 106. Further, the loudspeaker grid 114 may be shifted vertically along the side surface 102 to match an output of a sound channel of the loudspeaker device 100, as will be described below. In some non-limiting embodiments of the present technology, the loudspeaker grid 114 may be positioned, in the cross-section view depicted in FIG. 3, in front of an exit of a sound channel (such as at least one channel 204 depicted in FIG. 3) of the loudspeaker device 100, thereby conducting the given sound produced thereby to a surrounding environment thereof, as will be described below.

Further, according to certain non-limiting embodiments of the present technology, the loudspeaker device 100 may be implemented including a bass reflex enclosure. To that end, as depicted in FIGS. 2 and 3, the side surface 102 may define a bass reflex port 112 configured for coupling thereto a bass reflex tubing system 116 disposed within the side surface 102 of the acoustic assembly 120.

According to certain non-limiting embodiments of the present technology, the bass reflex tubing system 116 may be coupled to the top assembly 104, thereby forming a closed internal surface thereof. Further, a first edge 117 of the bass reflex port tubing system 116 may be coupled to the bass reflex port 112 of the loudspeaker device 100; whereas a second edge 119 of the bass reflex tubing system 116 may be coupled to an internal surface of the side surface 102 of the loudspeaker device 100. As such, in certain non-limiting embodiments of the present technology, the bass reflex tubing system 116 may be implemented as a Helmholtz resonator.

Further, in some non-limiting embodiments of the present technology, the bass reflex tubing system 116 may be damped for example, at the bass reflex port 112. In these embodiments, the damping may be implemented by covering the bass reflex port 112 with an acoustically transparent fabric (not depicted). Broadly speaking, the term “acoustically transparent”, as used herein, relates to properties of the fabric indicative of penetrability thereof to sound waves going therethrough. In some non-limiting embodiments, any acoustic textile may be used.

Further, in some non-limiting embodiments of the present technology, the bass reflex port 112 may further include at least one flare (not depicted) affixed thereto at an outside of the loudspeaker device 100. In these embodiments, the at least one flare (not depicted) may be configured for optimizing the geometry of the bass reflex tubing system 116 further allowing for minimizing effects of turbulization of air within the bass reflex tubing system 116 that could occur when at least one loudspeaker driver 118 produces the give sound. In some non-limiting embodiments of the present technology, the at least one flare may be implemented having a substantially conical form expanding outwardly and having respective dimensions.

Accordingly, in certain non-limiting embodiments of the present technology, the bass reflex tubing system 116 may thus be configured for minimizing sound distortions, caused by the turbulization of the air within the bass reflex tubing system 116, of the given sound produced by the loudspeaker device 100 at frequencies corresponding to the low range of the predetermined audio spectrum. In some non-limiting embodiments of the present technology, the bass reflex tubing system 116 may be configured for minimizing the sound distortions including at least one of overtones and nonlinear sound distortions.

In the context of the present specification the term “overtones” denotes undesired (unnecessary) sound waves having frequencies greater than a given fundamental one from the predetermined audio spectrum of the given sound produced by the at least one loudspeaker driver 118, which may cause distortions thereto, and as a result, to the overall clarity and quality thereof.

Further, in the context of the present specification, the term “nonlinear sound distortions” denotes a phenomenon of a non-linear relationship between an input signal of the at least one loudspeaker driver 118 and an output signal thereof. Such a phenomenon may occur, for example, when an electrical audio signal indicative of the given sound is supplied to the at least one loudspeaker driver 118 and is further converted into the respective sound waves, which include additional (undesired) harmonics indicative of frequencies that were absent in the electrical audio signal.

The bass reflex tubing system 116 may be configured for unloading sound pressure caused by the given sound produced by the loudspeaker device 100. As a result, efficiency of the loudspeaker device 100 at the frequencies corresponding to the low range may be increased. More specifically, in certain non-limiting embodiments of the present technology, the bass reflex tubing system 116 may be configured for the unloading the sound pressure off the loudspeaker device 100 at frequencies from around 100 Hz to around 200 Hz. Accordingly, in certain non-limiting embodiments of the present technology, the bass reflex tubing system 116 may be configured for minimizing a resonance frequency of the loudspeaker device 100, within the low range, to a level of around 100 Hz.

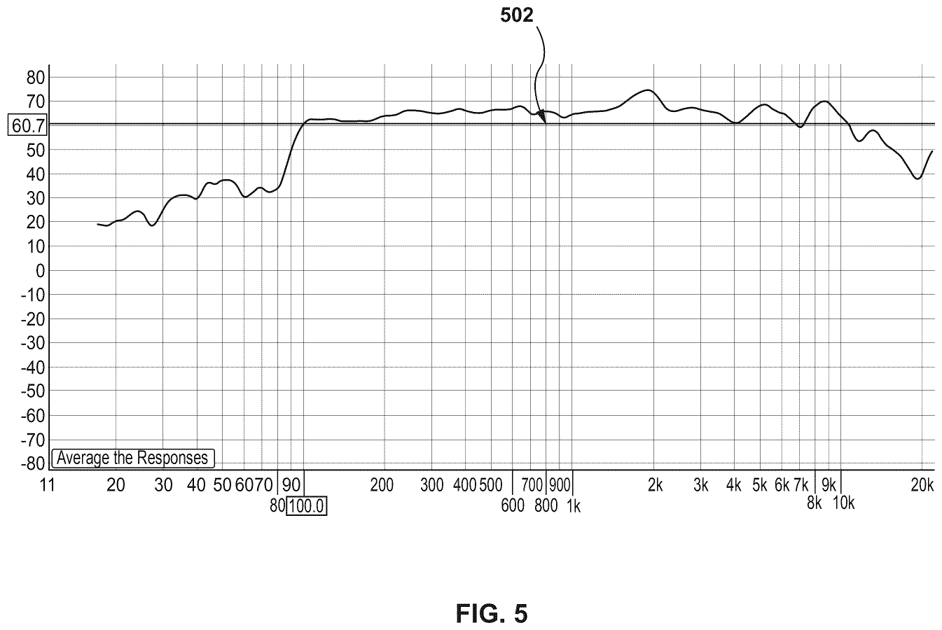

In the context of the present technology, the term “resonance frequency” of a given loudspeaker device, such the loudspeaker device 100, denotes a frequency level, below which an amplitude of the given sound produced by the loudspeaker device 100, drops significantly at a predetermined speed. In some non-limiting embodiments of the present technology, in a frequency response diagram, such as a frequency response diagram 502 depicted in FIG. 5, of the loudspeaker device 100, the amplitude of the given sound, below the resonance frequency, can drop at the predetermined speed equal to or greater than 3 dB per octave. Thus, in some implementations of the loudspeaker device 100, the resonance frequency thereof may define a lower boundary of the predetermined audio spectrum, within which the loudspeaker device 100 is configured to produce the given sound.

Further, in some non-limiting embodiments of the present technology, the side surface 102 may define various electrical signal ports (not depicted). The electrical signal ports may allow connecting the loudspeaker device 100 to an electrical power source and with other electronic devices (not depicted) using a wired connection. For example, referring to FIG. 4, the side surface 102 may define an audio port 308 allowing inputting an electrical audio signal (using an audio jack, as an example) indicative of the given sound to the loudspeaker device 100 from another electronic device.

According to certain non-limiting embodiments of the present technology, the side surface 102 may be configured for accommodating at least one loudspeaker driver 118 (also referred to herein as a “drive unit”) of the acoustic assembly 120 for reproducing the given sound, received, for example, from the audio port 308, by the loudspeaker device 100 within the predetermined audio spectrum. The given sound is a combination of sound waves having various audio frequencies. The at least one loudspeaker driver 118 may be accordingly configured to generate sound waves in the low range, the middle range, and the high range, as described above.

In some non-limiting embodiments of the present technology, the at least one loudspeaker driver 118 is a single loudspeaker driver, disposed within the housing of the loudspeaker device 100.

According to some non-limiting embodiments of the present technology, the at least one loudspeaker driver 118 may include a concave membrane 212 (also referred to herein as a “diaphragm” or a “loudspeaker driver diaphragm”) configured to convert the electrical audio signal provided to the loudspeaker device 100 into the given sound. The concave membrane 212 may be produced out of a thin material, such as polypropylene, polyether ether ketone, polycarbonate, biaxially-oriented polyethylene terephthalate, and the like, for providing a desired level of sensitivity to the at least one loudspeaker driver 118.

Finally, according to certain non-limiting embodiments of the present technology, the side surface 102, at a bottom thereof, may define a loudspeaker aperture 110 for receiving a loudspeaker flange of the at least one loudspeaker driver 118 such that the loudspeaker flange (not separately numbered) including the concave membrane 212 that faces towards the bottom assembly 106 of the loudspeaker device 100 when it is assembled. As it can be appreciated from FIG. 2, in these embodiments, the loudspeaker aperture 110 may be centered within the bottom (in the orientation of FIG. 2, not separately numbered) of the side surface 102 and may substantially follow the shape of the loudspeaker flange of the at least one loudspeaker driver 118.

Also, as depicted in FIGS. 2 and 3, in some non-limiting embodiments of the present technology, the bottom of the side surface 102 may be tapered downwardly to the bottom assembly 106, thereby defining a side protruding surface 202 oriented inwardly with respect to the side surface 102. Thus, the side protruding surface 202 may be defined at least partially over the bottom assembly 106 of the loudspeaker device 100.

In additional non-limiting embodiments of the present technology, the side surface 102 may be configured to accommodate a plurality of additional hardware components (not depicted) of the loudspeaker device 100, which has been omitted in the accompanying drawings for the sake of clarity and simplicity thereof as well as those of the present description. In this regard, the side surface 102 may additionally define respective mounting members for receiving each one of the plurality of additional hardware components (not depicted). For example, the plurality of additional hardware components of the loudspeaker device 100 may include a processor (not depicted). When the loudspeaker device 100 is assembled, the processor is communicatively coupled with the top assembly 104 (for example, by a wired connection), the at least one loudspeaker driver 118, and each one of the various electrical signal ports, such as the audio port 308.

It should be noted that, the processor, such as a Central Processing Unit (CPU) or specialized processors such as a Graphics Processing Unit (GPU) or other such processor unit, may be communicatively coupled via bi-directional bus to a memory, a non-transitory mass storage, an I/O interface, a network interface, and a transceiver. In some embodiments of the present technology, the processor may comprise one or more processors (cores) and/or one or more microcontrollers configured to execute instructions and to carry out operations associated with the operation of the speaker device 100, which includes, without limitation, instructions associated with receiving commands from the operator of the speaker device 100, instructions associated with generating indications in response to receipt thereof, and the like. In various non-limiting embodiments of the present technology, the processor may be implemented as a single-chip, multiple chips and/or other electrical components including one or more integrated circuits and printed circuit boards. The processor may optionally contain a cache memory unit for temporary local storage of instructions, data, or additional computer information. By way of example, the processor may include one or more processors, or one or more controllers dedicated for certain processing tasks of the speaker device 100 or a single multi-functional processor or controller.

Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), non-volatile storage, or a combination thereof.

Further, according to some non-limiting embodiments of the present technology, the plurality of additional hardware components (not depicted) of speaker device 100 may include a communication module (not depicted). Such communication module may be configured for implementing one of communication protocols (both wireless and wired) enabling the processor to be connected with other electronic devices or remote servers. Various examples of how the communication module may be implemented include, without being limited to, a Bluetooth™ communication module, a UART™ communication module, a Wi-Fi™ communication module, an LTE™ communication module, and the like.

According to the non-limiting embodiments of the present technology, communication between the processor and other ones of the plurality of additional hardware components, such as the communication module, as well as amongst each other, may be implemented by one or more internal and/or external buses (e.g. a PCI bus, universal serial bus, IEEE 1394 “Firewire” bus, SCSI bus, Serial-ATA bus, etc.), to which a respective one of the plurality of additional hardware components of the speaker device 100 is electronically coupled.

Further, according to certain non-limiting embodiments of the present technology, the bottom assembly 106 may define a conical protrusion 108 with its apex (not separately numbered) facing towards the loudspeaker flange (not separately numbered) of the at least one loudspeaker driver 118. In these embodiments, the apex of the conical protrusion 108 and a center of the loudspeaker flange of the at least one loudspeaker driver 118 may be located on a common vertical axis (not depicted), which may be substantially perpendicular to one of the top assembly 104 and the bottom assembly 106.

FIG. 3 illustrates the conical protrusion 108 as having a form of a truncated cone. It is understood that in other non-limiting embodiments of the present technology the conical protrusion 108 may have another form, for example, a form of a regular cone having a more explicit apex.

Thus, the side protruding surface 204 and an inner surface of the bottom assembly 106 may form a waveguide (not separately numbered) of the acoustic assembly 120 further defining at least one channel 204 of the loudspeaker device 100 configured for conducting the given sound produced by the at least one loudspeaker driver 118.

According to certain non-limiting embodiments of the present technology, the at least one channel 204, in a vertical cross-section thereof, may be structurally divided in at least three zones sequentially defined herein as a first zone, a second zone, and a third zone, each one of which will be described immediately below.

With continued reference to FIG. 3, in some non-limiting embodiments of the present technology, the first zone may be defined at least by a first cross-sectional dimension 206 of the at least one channel 204. As it can be appreciated from FIG. 3, the first cross-sectional dimension 206 may be determined between the apex of the conical protrusion 108 and the center of the flange of the at least one loudspeaker driver 118. In these embodiments, the first cross-sectional dimension 206 may be determined to minimize resonance phenomena at frequencies of the given sound corresponding to the middle range and the high range of the predetermined audio spectrum. The term “a resonance phenomenon”, as used herein, refers to a phenomenon of a significant increase of the amplitude of the given sound at respective frequency levels. For example, in the frequency response diagram 502 of the loudspeaker device 100, a given resonance phenomenon may be defined as a peak of the amplitude of the given sound, at a respective frequency level, having a rise followed by a respective fall, at least one of which is equal to or greater than 6 dB per octave.

More specially, in some non-limiting embodiments of the present technology, the first zone may thus be configured for minimizing the resonance phenomena of the given sound at frequencies from around 500 Hz to around 20000 Hz. Thus, in specific non-limiting embodiments of the present technology, the first cross-sectional dimension 206 may be selected from a first predetermined distance range spanning from around 2 mm to around 4 mm. In some non-limiting embodiments, the first cross-sectional dimension 206 may be selected to be minimum possible for the overall dimension of the loudspeaker device 100, while achieving the above-described function.

Further, according to certain non-limiting embodiments of the present technology, the second zone may be defined by a second cross-sectional dimension 208 of the at east one channel 204. As it can be appreciated from FIG. 3, the second zone may be characterized by a substantial narrowing of the at least one channel 204 after the first zone. In certain non-limiting embodiments of the present technology, the second zone may thus be defined as a “slit” within the at least one channel 204.

In some non-limiting embodiments of the present technology, the second zone may thus be configured for providing maximum values of acoustic resistance to the given sound conducted thereto from the first zone. Accordingly, in these embodiments, the second zone may be configured for controlling an input of the given sound therefrom to the third zone.

According to certain non-limiting embodiments of the present technology, the second cross-sectional dimension 208 may be selected from a second predetermined distance range from around 2 mm to around 4 mm.

Finally, in certain non-limiting embodiments of the present technology, the third zone may be defined by a third cross-sectional dimension 210. In other words, as it can be appreciated from FIG. 3, the third zone maybe defined by a gradual extension of the at least one channel 204 from the second cross-sectional dimension 208 to the third cross-sectional dimension 210 at an exit of the at least one channel 204, thereby further defining a trumpet structure of the loudspeaker device 100.

Thus, according to certain non-limiting embodiments of the present technology, the third zone maybe configured for amplifying the amplitude of the given sound produced, by the at least one loudspeaker driver 118, at at least some frequencies corresponding to the high range of the predetermined audio spectrum. In these embodiments, the amplifying maybe from around 15 dB to around 20 dB, as an example.

Further, the third zone maybe configured for attenuating the amplitude of the given sound at at least other frequencies corresponding to the low range and the middle range of the predetermined audio spectrum. As it may become apparent, in these embodiments, the attenuating maybe performed by virtue of a diffraction phenomenon occurred within the third zone and allowing the sound waves of the given sound to go around the housing of the loudspeaker device 100.

Thus, the third zone maybe configured for providing a uniform sound field around the loudspeaker device 100. In accordance with certain non-limiting embodiments of the present technology, the uniform sound field maybe defined as a sound field produced by the given sound, within which, at a predetermined distance from the loudspeaker device 100 within the vicinity thereof, the frequency response to the given sound is substantially consistent, that is, a variation of the amplitude of the given sound, at each and every frequency level within the predetermined audio spectrum does not exceed 3 dB. In some non-limiting embodiments of the present technology, the uniform sound filed may have a spherical profile. Such configuration of the uniform sound field hence produced around the loudspeaker device 100 may allow providing a more realistic reproduction of the given sound to a user of the loudspeaker device 100.

In some non-limiting embodiments of the present technology, the third cross-sectional dimension 210 maybe determined based on a wavelength value corresponding to an upper boundary of the predetermined audio spectrum associated with the loudspeaker device 100. Thus, in specific non-limiting embodiments of the present technology, the third cross-sectional dimension 210 maybe selected from a third predetermined distance range from around 15 mm to around 20 mm.

According to certain non-limiting embodiments of the present technology, a respective optimal value of each one of the first cross-sectional dimension 206, the second cross-sectional dimension 208, and the third cross-sectional dimension 210, within a respective one of the first predetermined distance range, the second predetermined distance range, and the third predetermined distance range, may be determined by iteratively altering at least one thereof, such that the consistency of the frequency response of the loudspeaker device 100 to the given sound, within the predetermined audio spectrum, is maximized.

In some non-limiting embodiments of the present technology, the altering may be performed using a predetermined step, which may be from around 0.5 mm to around 1 mm, as an example. Further, the altering, at each iteration, may be followed by producing models of the loudspeaker device 100, out of, for example, plastic and/or modelling clay, for verifying at least some of acoustic parameters of the loudspeaker device 100. In certain non-limiting embodiments of the present technology, the at least some acoustic parameters may include a span of the predetermined audio spectrum and the consistency of the frequency response diagram therewithin. Thus, overall geometry of the at least one channel 204 may be defined within the loudspeaker device 100.

FIG. 5 depicts an example of the frequency response diagram 502 to the given sound produced by the loudspeaker device 100, in accordance with certain non-limiting embodiments of the present technology.

As it can be appreciated, the frequency response diagram 502 is representative of substantially constant amplitude values, that is, around 60 dB, as an example, within frequency levels of around 100 Hz and around 20000 Hz. Further, the frequency response diagram 502 does not include any resonance phenomena representative of respective rises and falls, within the frequency response diagram 502, greater than 6 dB per octave, which may be indicative of a smoother distribution of the given sound in the outside environment of the loudspeaker device 100.

Certain non-limiting embodiments of the present technology are directed to a loudspeaker device enclosed within a compact housing and including a single loudspeaker driver—such as the loudspeaker device 100, whose frequency response is substantially consistent within the predetermined audio spectrum from around 100 Hz to around 20000 Hz.

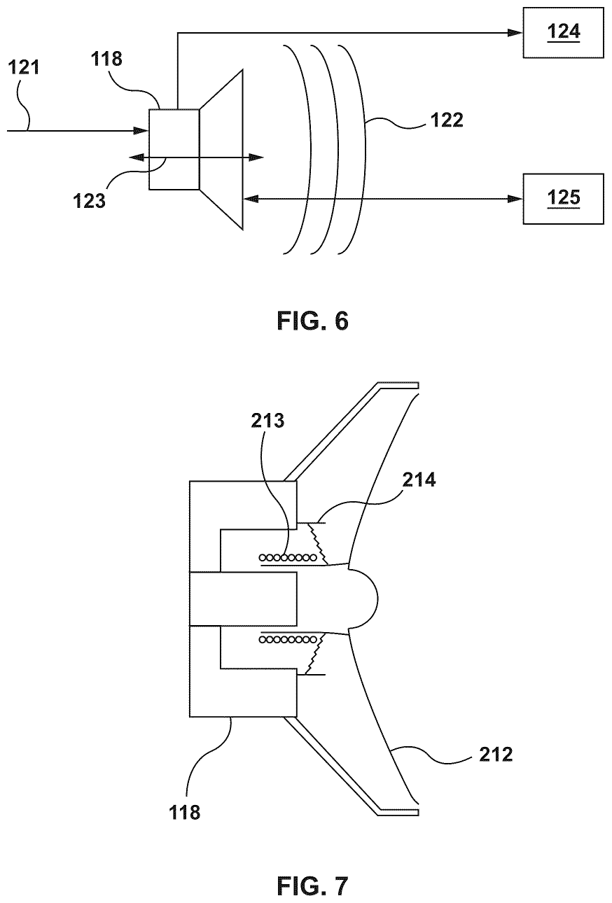

FIG. 6 shows an embodiment of loudspeaker driver 118 receiving input electrical signal 121 and converting input electrical signal 121 into respective sound 122. FIG. 6 also shows vibration 123 of loudspeaker driver 118. The instant application discloses a method and an processor (to execute this method) to identify and mitigate vibrations associated with a loudspeaker driver. Broadly speaking, the processor is configured to calculate a “corrective” sound distortion to be generated by the loudspeaker driver when music (or any other sound) is played back to compensate and/or mitigate the distortion of output sound, including nonlinear sound distortion. The method may include: action (i), when a first audio signal comprising the content (for example, a music song) is inputted to the loudspeaker; action (ii), when, the inputted first audio signal causes vibration of the loudspeaker and a signal detector recognizes the loudspeaker vibration or, following receipt of the first audio signal, the signal detector anticipates vibration of the loudspeaker; action (iii), when, following the signal detector recognizing or anticipating the loudspeaker vibration, a generator generates a compensation signal; action (iv), when the generator generates a second audio signal, the second audio signal is based, at least in part, on the first audio signal, or the compensation signal, or both; and action (v), when the second audio signal is inputted to the loudspeaker driver.

A mathematical model of a loudspeaker may be described by equation (3.1):

$$\frac{{d}^{2} x}{{dt}^{2}} = \frac{b ( x )}{{mR}_{e}} u ( w ) - ( \frac{{( b ( x ) )}^{2}}{{mR}_{e}} + \frac{{R}_{m}}{m} ) \frac{dx}{dt} - \frac{k ( x )}{m} x$$

wherein: Rₑ—direct current (DC) resistance of the loudspeaker driver; b(x)—flux linkage coefficient of loudspeaker driver 118; k(x)—coefficient of hardness; Rm—coefficient of viscosity; m—diaphragm mass; w—original (undistorted) voltage; and u(w)—pre-distorted (corrected) voltage applied to the loudspeaker driver.

FIG. 7 illustrates the cross-sectional view of an embodiment of loudspeaker driver 118 with diaphragm 212, diaphragm suspension 214, and voice coil 213. Diaphragm 212 and diaphragm suspension 214 define coefficient of hardness k(x), and voice coil 213 defines flux linkage coefficient used in equation (3.1).

Equation (3.1) is a nonlinear differential equation, wherein coefficients b(x) and k(x) are nonlinear functions of x. A desired response of a loudspeaker is a linear function of the original (undistorted) voltage w. This means that b(x) and k(x) should be constant values. For example, b(x) and k(x) may be approximated to their values at x=0.

$$\frac{{d}^{2} x}{{dt}^{2}} = \frac{{b}_{0}}{{mR}_{e}} w - ( \frac{{b}_{0}^{2}}{{mR}_{e}} + \frac{{R}_{m}}{m} ) \frac{d x}{dt} - \frac{{k}_{0}}{m} x , \qquad Equation ( 3.2 )$$

$$where {k}_{0} = k ( 0 ) , {b}_{0} = b ( 0 ) .$$

By equating the left sides of equations 3.1 and 3.2, one may arrive to equation (3.3). Equation (3.3) is an equation of compensated nonlinear distortions in the low frequency region:

$$u ( w ) = \frac{{b}_{0}}{b ( x )} w - ( \frac{{b}_{0}^{2} - {( b ( x ) )}^{2}}{b ( x )} ) \frac{d x}{dt} - \frac{{k}_{0} - k ( x )}{b ( x )} {R}_{e} x \qquad Equation ( 3.3 )$$

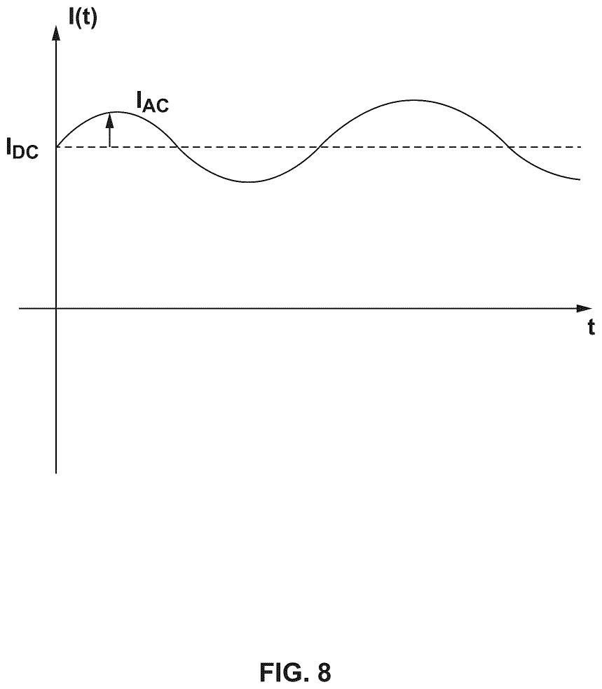

To evaluate variation of b(x) and k(x), one may carry out a sequence of experiments. For example, an experiment may include the following actions: action (i), when a DC current (I_{DC}) is applied to the loudspeaker driver, which drives the loudspeaker driver diaphragm to a fixed excursion; action (ii), when, following action (i), a small alternating current (I_{AC}) is mixed to the DC current as shown in FIG. 8; and action (iii), when the voltage drop across the loudspeaker driver is measured and a set of loudspeaker impedance curves is acquired. Using the method of gradient descent, the resulting loudspeaker impedance curves may be closely matched to complex equation (3.4) (the inductance of the loudspeaker driver may be assumed to be negligible):

$${Z}_{speaker} ( f ) = \frac{u ( s )}{i ( s )} = {R}_{e} + \frac{{s ( b ( x ) )}^{2}}{{s}^{2} m + {sR}_{m} ( x ) + k ( x )} , \qquad Equation ( 3.4 )$$

$$where s = j 2 π f .$$

The method of gradient descent may be executed by the processor disclosed in the instant application. It should be also noted that some or all parameters of loudspeaker driver 118 could be estimated from equation (3.4).

Analyzing instant impedances may include the following actions: Action (i)—from the original data set, identifying the relative flux linkage coefficient

$$\frac{b ( x )}{{b}_{0}} ;$$

Action (ii)—identifying the coefficient of elasticity of diaphragm suspension 214 and diaphragm 212:

$$\frac{{k}_{0} - k ( x )}{{k}_{0}} \frac{{b}_{0}}{b ( x )}$$

Expressions

$$\frac{b ( x )}{{b}_{0}} and \frac{{k}_{0} - k ( x )}{{k}_{0}} \frac{{b}_{0}}{b ( x )}$$

seem counterintuitive. However, presented in relative terms these expressions are much more suitable for practical purposes.

The second term of equation 3.4 represents the mechanical impedance of the loudspeaker driver:

$${Z}_{speaker} ( f , x ) - {R}_{e} = \frac{{s ( b ( x ) )}^{2}}{{s}^{2} m + s {R}_{m} + k ( x )} \qquad Equation ( 3.5 )$$

The cyclic resonant frequency of a loudspeaker may be defined in this disclosure as a function of an excursion of a diaphragm of the loudspeaker:

$${ω}_{r} ( x ) = \sqrt{\frac{k ( x )}{m}} .$$

The of mechanical quality factor may be defined by question:

$$Q ( x ) = \sqrt{\frac{k ( x ) \cdot m}{{R}_{m}}} .$$

Both parameters

$$( {ω}_{r} ( x ) = \sqrt{\frac{k ( x )}{m}} and Q ( x ) = \sqrt{\frac{k ( x ) \cdot m}{{R}_{m}}} )$$

can be reliably estimated from the shape of the impedance curve. Equation (3.5) may be rearranged in a general form (3.6):

$$\frac{{s ( b ( x ) )}^{2}}{{s}^{2} m + s {R}_{m} + k ( x )} = \frac{{s ( b ( x ) )}^{2}}{k ( x ) ( \frac{{s}^{2} m}{k ( x )} + \frac{s {R}_{m}}{k ( x )} + 1 )} = \frac{{s ( b ( x ) )}^{2}}{k ( x ) ( \frac{{s}^{2}}{{ω}_{r}^{2} ( x )} + \frac{s}{{ω}_{r} ( x ) \cdot Q ( x )} + 1 )}$$

The stiffness coefficient may be defined by the cyclic resonant frequency as in equation (3.7):

$${ω}_{r} ( x ) = \sqrt{\frac{k ( x )}{m}} ⇒ k ( x ) = {ω}_{r}^{2} ( x ) \cdot m$$

The stiffness coefficient at an instant excursion x0 may be defined by expression: k(x₀)=ωᵣ²(x₀)·m.

x0 may be chosen arbitrarily, and not necessarily equal to zero. Equation (3.7) for the stiffness coefficient may be rearranged as equation:

$$k ( x ) = k ( {x}_{0} ) \frac{{ω}_{r}^{2} ( x )}{{ω}_{r}^{2} ( {x}_{0} )}$$

Consequently, equation (3.6) may be rearranged as equation (3.8):

$${Z}_{speaker} ( f , x ) - {R}_{e =} \frac{{s ( b ( x ) )}^{2}}{{s}^{2} m + {sR}_{m} + k ( x )} = \frac{{b}^{2} ( x )}{k ( {x}_{0} ) \frac{{ω}_{r}^{2} ( x )}{{ω}_{r}^{2} ( {x}_{0} )}} ( \frac{s}{\frac{{s}^{2}}{{ω}_{r}^{2} ( x )} + \frac{s}{{ω}_{r} ( x ) \cdot Q ( x )} + 1} )$$

FF(x) is a new notation introduced in the instant disclosure. FF(x) does not depend on frequency:

$$FF ( x ) = \frac{{b}^{2} ( x )}{k ( {x}_{0} ) \frac{{ω}_{r}^{2} ( x )}{{ω}_{r}^{2} ( {x}_{0} )}}$$

Taking into account FF(x), equation (3.8) may be rearranged into equation (3.9):

$${Z}_{speaker} ( f , x ) - {R}_{e} = \frac{{s ( b ( x ) )}^{2}}{{s}^{2} m + {sR}_{m} + k ( x )} = FF ( x ) ( \frac{s}{\frac{{s}^{2}}{{ω}_{r}^{2} ( x )} + \frac{s}{{ω}_{r} ( x ) \cdot Q ( x )} + 1} )$$

The quality factor, cyclic resonant frequency and FF(x) in equation (3.9) may be reliably identified by the method of gradient descent. Of these three parameters only FF(x) has a practical application, as FF(x) may be used to express the flux linkage coefficient in relative terms. To do so, one has to consider the ratio of FF(x) at an arbitrary excursion of the diaphragm of the loudspeaker driver to the value of FF(x₀) at the reference point x₀:

$$\frac{FF ( x )}{FF ( {x}_{0} )} = \frac{\frac{{b}^{2} ( x )}{k ( {x}_{0} ) \frac{{ω}_{r}^{2} ( x )}{{ω}_{r}^{2} ( {x}_{0} )}}}{\frac{{b}^{2} ( {x}_{0} )}{k ( {x}_{0} )}} = \frac{{b}^{2} ( x )}{{b}^{2} ( {x}_{0} )} \frac{{ω}_{r}^{2} ( {x}_{0} )}{{ω}_{r}^{2} ( x )}$$

Consequently, the flux linkage coefficient in relative terms may be expressed as equation (3.10):

$${( \frac{b ( x )}{b ( {x}_{0} )} )}^{2} = \frac{FF ( x )}{FF ( {x}_{0} )} {( \frac{{ω}_{r} ( x )}{{ω}_{r} ( {x}_{0} )} )}^{2} ⇒ \frac{b ( x )}{b ( {x}_{0} )} = \frac{{ω}_{r} ( x )}{{ω}_{r} ( {x}_{0} )} \sqrt{\frac{FF ( x )}{FF ( {x}_{0} )}}$$

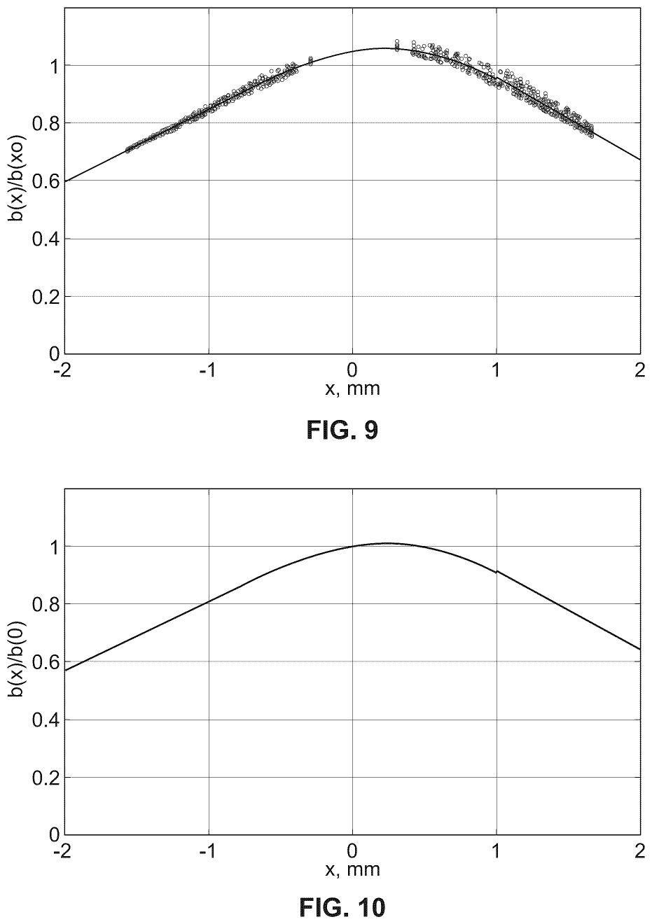

FIG. 9 shows a graph of experimentally obtained estimates of b(x)/b(x₀) ration. Empirical data, presented in FIG. 9, may be piecewise approximated using the least squares method. The least square method may be executed by the processor disclosed in the instant application. The central interval, corresponding to excursions of diaphragm 212 of loudspeaker driver 118 between −1 mm and +1 mm, may be approximated by an eighth-degree polynomial function. The intervals on the left and right from the central interval may be approximated by linear functions. The value of x₀ reference point may be chosen. For example, it may be selected to be equal to −0.3 mm. It may be desirable to have the relative value of the flux linkage coefficient equal to one, for example, when there is no displacement of diaphragm 212 of loudspeaker driver 118. Therefore, all obtained polynomial coefficients may be divide by the value of the approximating polynomial function at the zero point.

FIG. 10 shows the approximated function of b(x)/b(0). A significant constant may appear in the output signal of the descript audio codec (DAC) when there is asymmetry between the positive and negative half-waves in the spectrum of the sequence imputed to the DAC. The constant may be filtered out by blocking capacitors and therefore may not reach the loudspeaker driver. Therefore, correlation between the generated digital signal (imputed to the DAC) and the voltage applied to the loudspeaker driver may be affected. This issue may be addressed by balancing—shifting the experimentally obtained function b(x)/b(0) to attain axial symmetry. For example, a substitution (3.11)

$${[ \frac{b ( x )}{b ( {x}_{0} )} ]}_{centered} = \frac{1}{2} ( [ \frac{b ( x )}{b ( 0 )} ] + [ \frac{b ( - x )}{b ( 0 )} ] )$$

may be used.

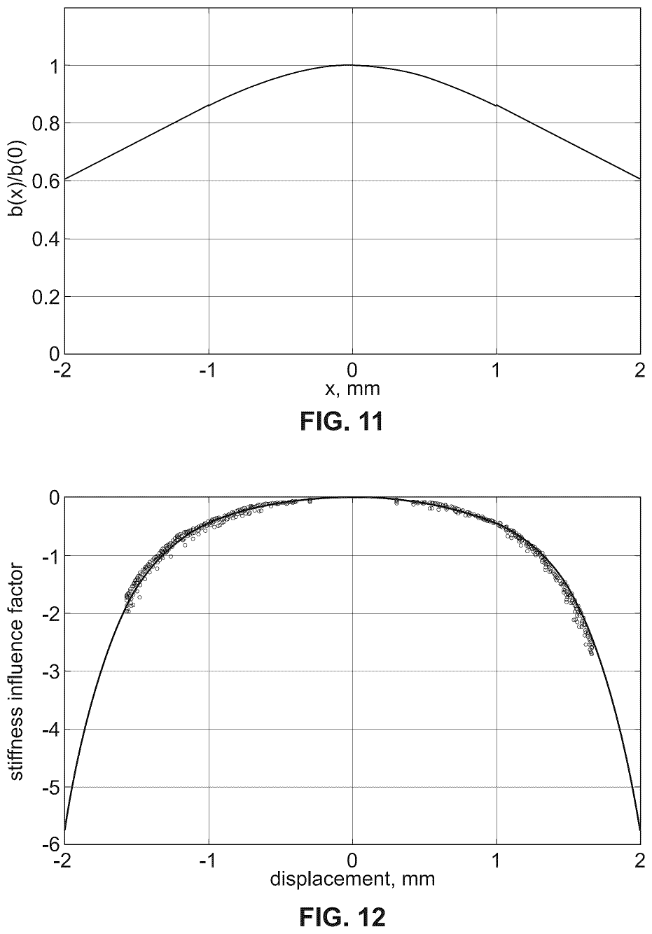

FIG. 11 shows the b(x)/b(0) function after substitution (3.11) was applied.

Stiffness coefficient k(x) may be defined as in equation (3.7). Therefore

$$\frac{k ( x )}{{k}_{0}} = \frac{{ω}_{r}^{2} ( x )}{{ω}_{r}^{2} ( 0 )}$$

The coefficient of elasticity

$$\frac{k ( x )}{{k}_{0}} = \frac{{b}_{0}}{b ( x )}$$

may be defined as equation (3.12)

$$\frac{{k}_{0} - k ( x )}{{k}_{0}} = 1 - \frac{{ω}_{r}^{2} ( x )}{{ω}_{r}^{2} ( 0 )} ⇒ \frac{{k}_{0} - k ( x )}{{k}_{0}} \frac{{b}_{0}}{b ( x )} = ( 1 - \frac{{ω}_{r}^{2} ( x )}{{ω}_{r}^{2} ( 0 )} ) {( \frac{b ( x )}{{b}_{0}} )}^{- 1}$$

Balancing of the b(x)/b(0) function was already discussed. The coefficient of elasticity and the coefficient of relative flux linkage may require balancing (shifting to attain axial symmetry) for the same reasons.

$${[ \frac{{k}_{0} - k ( x )}{{k}_{0}} \frac{{b}_{0}}{b ( x )} ]}_{centered} = \frac{1}{2} ( [ \frac{{k}_{0} - k ( x )}{{k}_{0}} \frac{{b}_{0}}{b ( x )} ] + [ \frac{{k}_{0} - k ( - x )}{{k}_{0}} \frac{{b}_{0}}{b ( - x )} ] ) \qquad Equation ( 3.13 )$$

FIG. 12 shows a graph of the coefficient of elasticity in dimensionless units. The graph is axially symmetrical after balancing.

The mathematical model presented in this disclosure may be used to compensate or mitigate nonlinear distortions of output sound of loudspeaker driver 118. Equation 3.3 may be rearranged as expression:

$$u ( w ) = \frac{{b}_{0}}{b ( x )} w - {b}_{0} \frac{b ( x )}{{b}_{0}} ( {( \frac{{b}_{0}}{b ( x )} )}^{2} - 1 ) \frac{dx}{dt} - ( \frac{{k}_{0} - k ( x )}{{k}_{0}} \frac{{b}_{0}}{b ( x )} ) \frac{{k}_{0} {R}_{e}}{{b}_{0}} x$$

This equation contains two undetermined coefficients: b₀ and

$$\frac{{k}_{0} {R}_{e}}{{b}_{0}} .$$

Because values of these coefficients are not constant, they may be adjusted.

$$u ( w ) = \frac{{b}_{0}}{b ( x )} w - {K}_{speed} \frac{b ( x )}{{b}_{0}} ( {( \frac{{b}_{0}}{b ( x )} )}^{2} - 1 ) \frac{dx}{dt} - {K}_{stiffness} ( \frac{{k}_{0} - k ( x )}{{k}_{0}} \frac{{b}_{0}}{b ( x )} ) x \qquad Equation 3.14$$

may be used to calculate the pre-distorted voltage. K_{speed}, and K_{stiffness} are coefficients, the values of these coefficients are defined by the instant values of the diaphragm displacement and speed. These coefficients may be also manually selected to compensate distortions in most effective way.

An aspect of the present disclosure is a method to define an instant displacement of diaphragm 212 of loudspeaker driver 118 based on a set of previous voltage measurements. The method of the present disclosure may allow to mitigate or compensate nonlinear sound distortions of loudspeaker driver 118 without receiving a feedback signal. Such an approach may allow for faster and more accurate determination of the current state of loudspeaker driver 118.

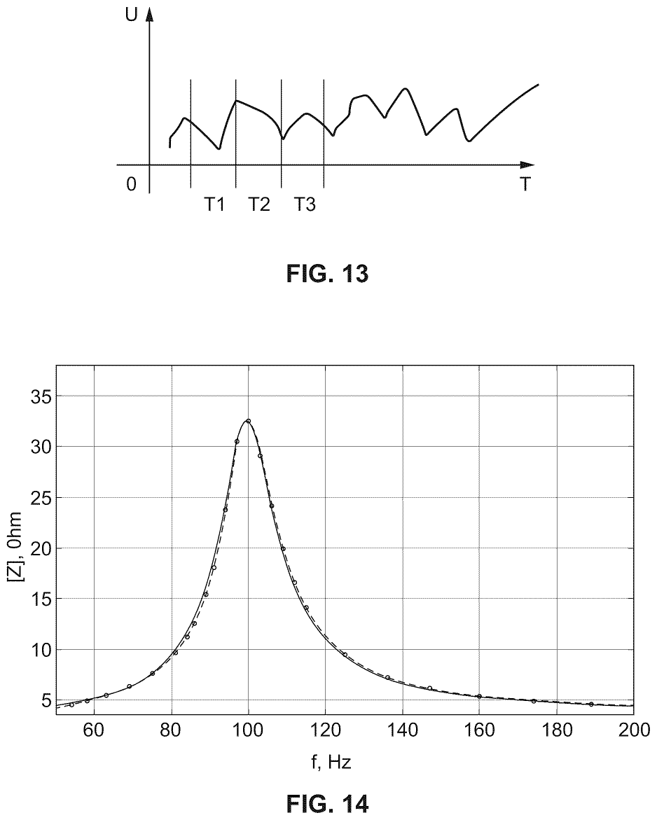

Engaged loudspeaker driver 118 may vibrate as shown in FIG. 6. Movement of loudspeaker driver 118 may occur along one axis, e.g., horizontally to the loudspeaker body as loudspeaker driver 118 vibrates during playback. Loudspeaker driver 118 may comprise voltage sensor 124. Voltage sensor 124 may track the voltage drop across loudspeaker driver 118 as shown in FIG. 13. Laser sensor 125 may be used to track displacement of diaphragm 212 of loudspeaker driver 118. Table 1 shows a set of measurements of voltage drop across loudspeaker driver 118 and displacement of diaphragm 212.

TABLE 1

| | | Displace- |
|---|---|---|
| Time | Voltage | ment, mm |
| T1 | U(T1) | +0.01 |
| T2 | U(T2) | +0.02 |
| T3 | U(T3) | −0.01 |
| . . . | . . . | . . . |

Validation of the mathematical model of loudspeaker driver 118 may require to assess dependences of nonlinear parameters from a displacement of diaphragm 212. In this disclosure the loudspeaker driver impedance dependency from frequency was examined. The dependence of the loudspeaker driver impedance was evaluated at a plurality of displacements of diaphragm 212 from its position of balance.

An electric current, supplied to loudspeaker driver 118 under the test, had two components: constant current I_{DC} and variable current I_{AC} as shown in FIG. 8.

$$I ( t ) = {I}_{DC} + {I}_{AC} and {U}_{AC} \approx {I}_{AC} Z ;$$

At an instant amplitude of I_{AC}, the voltage drop across loudspeaker driver 118 is proportional to its electrical impedance. Thus, stimulating loudspeaker driver 118 with input current of different frequencies one may indirectly obtain an impedance curve of loudspeaker driver 118 at a fixed bias. I_{DC} may assume positive and negative values. However, I_{DC} of the loudspeaker driver under the test is limited by its operational range. I_{DC} was maintained in the range between 0 and 3 Amperes. The amplitude of I_{AC} was sufficiently small (limited to the range between 0 and 100 mA), so that a response to applied I_{AC} would qualify as linear. I_{AC} was a sinusoid wave, adjustable within frequency range from 50 Hz to 15 kHz. A displacement of diaphragm 212 together with a voltage drop across loudspeaker driver 118 (both constant and variable components) were measured at each selected value of the electric current, imputed to loudspeaker driver 118. The experimental data, collected as described above, was used to identify a set of linear transfer functions of loudspeaker driver 118 at different bias (I_{DC}) points, and static characteristics of loudspeaker driver 118 (bias, current-voltage characteristics).

FIG. 14 illustrates approximated impedance of loudspeaker driver 118 under the test. The method of gradient descent was used for approximation. This procedure may require 500 or more randomly generated excursions of the loudspeaker diaphragm within its acceptable range. For each randomly generated displacement of the diaphragm, application of I_{AC} at 20 or more different frequencies may be required. This procedure is time consuming. Moreover, I_{DC} of 1 Amp or more, applied to a loudspeaker driver for 10 sec or longer may damage the loudspeaker driver.

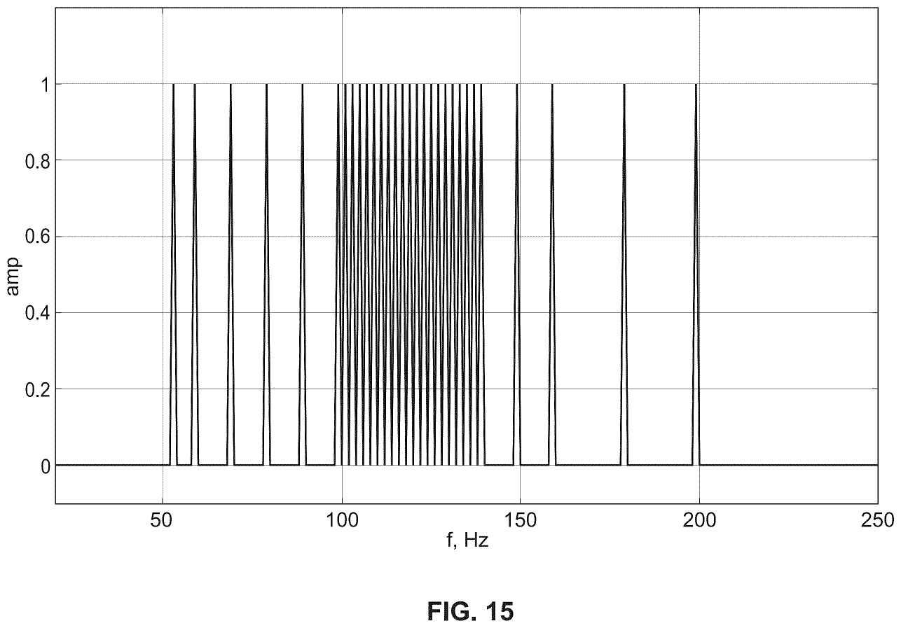

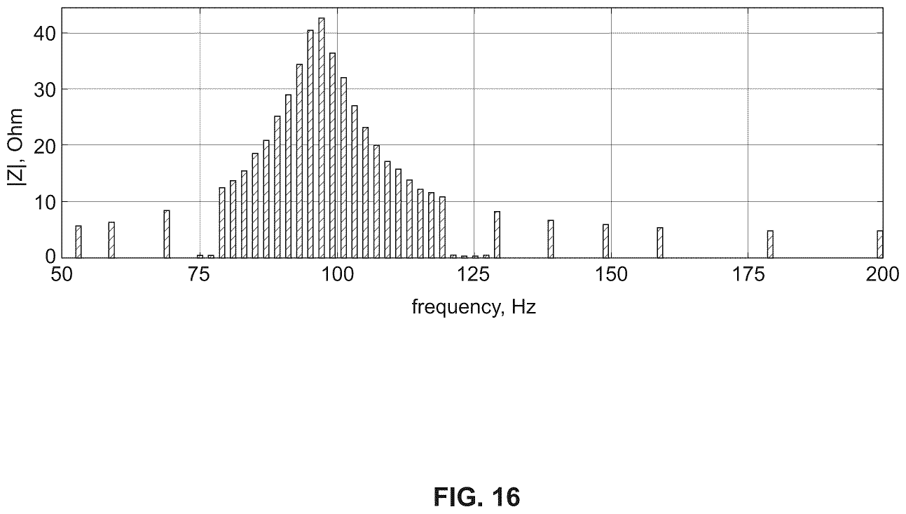

To accelerate acquisition of experimental data and avoid damaging the loudspeaker driver the orthogonal frequency-division multiplexing (OFDM) measurement method was used in this disclosure. OFDM pulses with multiple closely spaced orthogonal subcarrier signals were used to stimulate loudspeaker driver 118 under the test. FIG. 15 shows an example of I_{AC} in the frequency domain. Selection of subcarrier signals may depend on the size of loudspeaker driver 118 and its resonance frequency. The amplitude spectrum of the measured voltage drop across loudspeaker driver 118 may be proportional to the impedance of loudspeaker driver 118 when the loudspeaker driver input current properly synchronized with the voltage measurements (voltage drop across loudspeaker driver 118) as shown in FIG. 16.

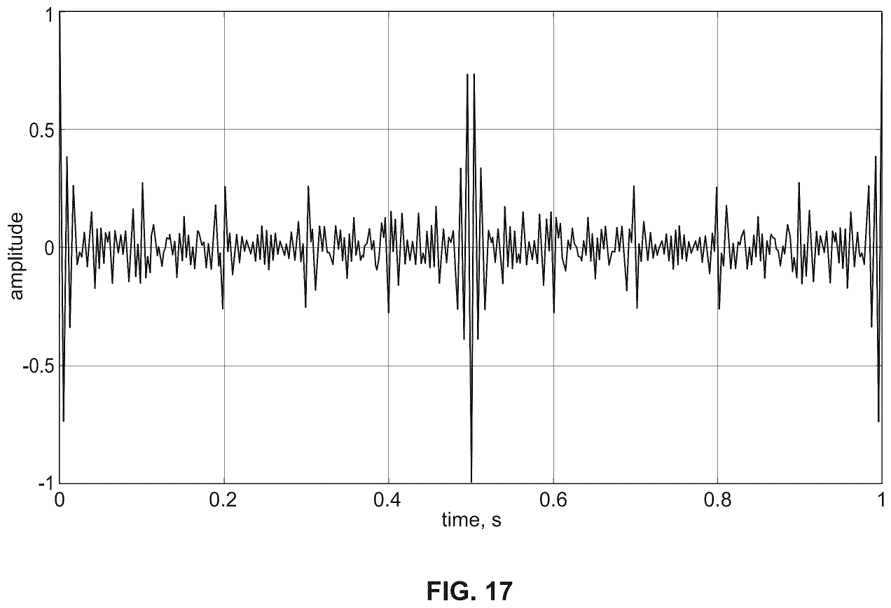

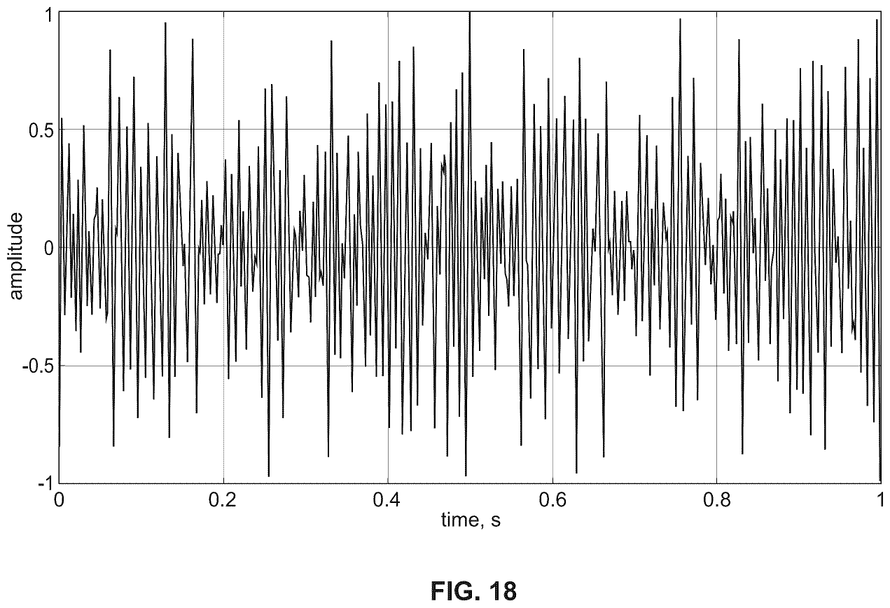

A single OFDM pulse estimates values of the loudspeaker driver impedance at several points of interest in the frequency domain. Frequency resolution of the OFDM method is inversely proportional to the duration of the time period. For example, for 2 Hz resolution, a period of 0.5 sec is required. For a resolution of 1 Hz, 1 sec period is required. The dynamic range of the measured signal decreases when the number of frequency samples increases. A large number of orthogonal subcarrier signals in the OFDM pulse leads to a higher value of phase noise. For example, at 30 measurement points, 50 Hz noise and its subcarriers may become noticeable. Precise OFDM signal synchronization is required. Subcarriers phases in the OFDM signal should be randomly selected to minimize the peak factor of the signal. FIGS. 17 and 18 illustrate OFDM time graphs of the voltage drop across loudspeaker driver 118 when coherent subcarriers and randomly selected subcarriers were used, respectively.

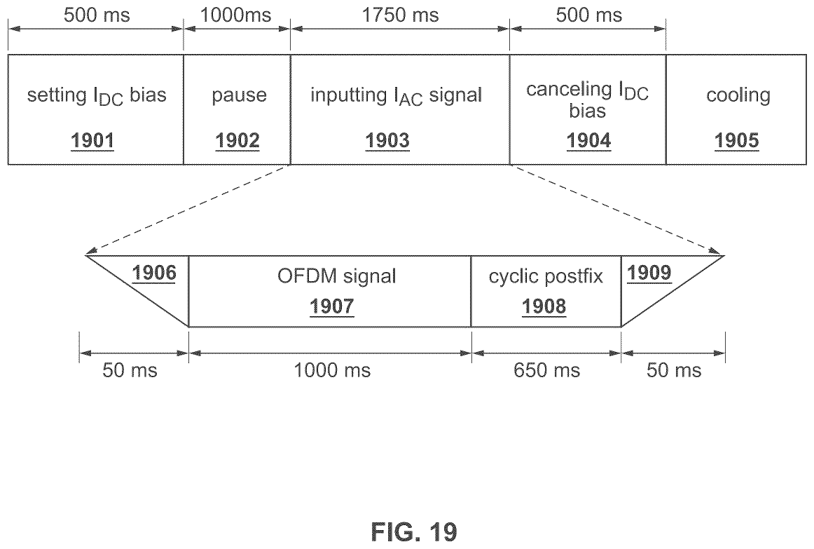

FIG. 19 illustrates a time diagram of the OFDM measurement procedure executed by a processor. At action 1901 (500 ms) a selected I_{DC} bias is applied to loudspeaker driver 118 under the test; action 1902 is a pause of 1000 ms, preceding to action 1903 when a selected I_{AC} signal is inputted to loudspeaker driver 118. Action 1903 takes 1750 ms. One OFDM measurement cycle takes 3.25 seconds (action 1904—canceling IDC bias and action 1905—forced cooling of the loudspeaker driver are not included). Direct measurements of the voltage drop across loudspeaker driver 118 are performed during action 1903. Action 1903 comprises action 1907, followed by action 1908 as shown in FIG. 19. Action 1907 accounts for the OFDM signal of 1000 ms duration. Experimentally achieved maximum frequency resolution was 2 Hz. Action 1908 is a cyclic postfix period of 573 ms. This period is used for synchronization. At both ends of the measuring interval (the measuring interval comprises action 1907 and action 1908), 50 ms transitional intervals are located. These transitional intervals are depicted on the diagram as action 1906 and action 1909.

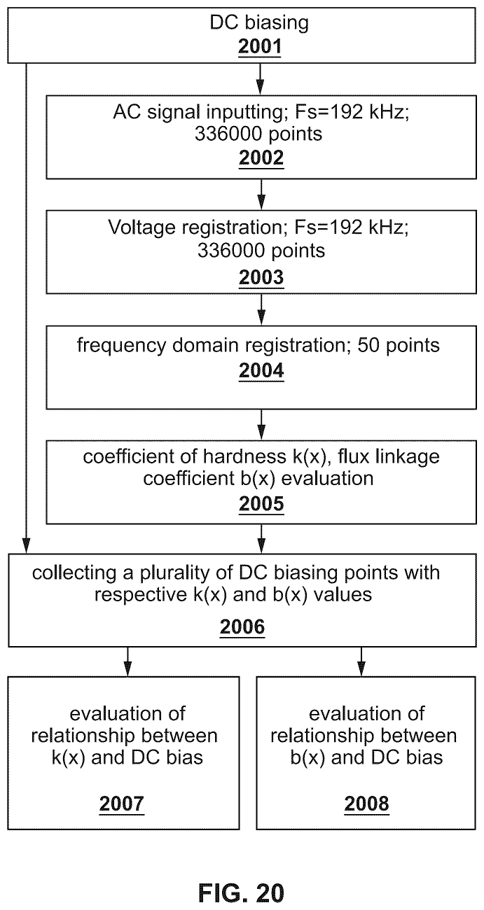

FIG. 20 illustrates a flowchart for evaluation of k(x) and b(x) of the loudspeaker driver model. The evaluation may be executed by a processor. At action 2001, a DC current (I_{DC}) is applied to the loudspeaker driver under the test, which drives the loudspeaker driver diaphragm to a fixed displacement. At action 2002, a small alternating current (I_{AC}) is mixed to the DC current (336000 points at sampling rate fₛ=192 kHz). At action 2003, voltage drop across the loudspeaker driver under the test is measured (336000 points at fs=192 kHz). At action 2004, frequency domain registration is performed (50 pairs—amplitude and frequency). At action 2005, the method of least squares is used to evaluate coefficient of hardness k(x) and flux linkage coefficient b(x). At action 2006, a plurality of DC biasing points (a plurality of displacements of the loudspeaker driver diaphragm) with respective k(x) and b(x) values is defined. At action 2007, the method of least squares (polynomial function of 8^{th} degree) is used to evaluate the relationship between k(x) and the diaphragm displacement. At action 2008, the method of least squares (polynomial function of 12^{th} degree) is used to evaluation the relationship between b(x) and the diaphragm displacement.

To evaluate variation of b(x) and k(x), one may carry out a sequence of experiments. For example, an experiment may include the following actions executed by a processor in a computing environment: action (i), when a DC current (I_{DC}) is applied to the loudspeaker driver, which drives the loudspeaker driver diaphragm to a fixed excursion; action (ii), when, following action (i), I_{AC} is applied, as shown in FIG. 8; and Action (iii), when the voltage drop across the loudspeaker driver is measured and a set of loudspeaker impedance curves is acquired. Using the method of gradient descent, the resulting loudspeaker impedance curves may be closely matched to complex equation (3.4) (the inductance of the loudspeaker driver is assumed to be negligible):

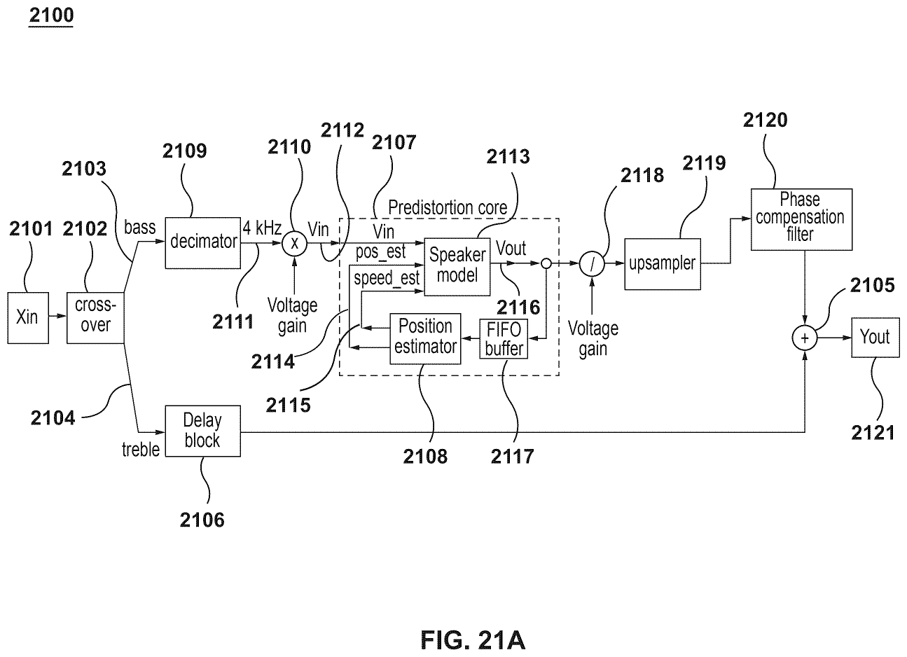

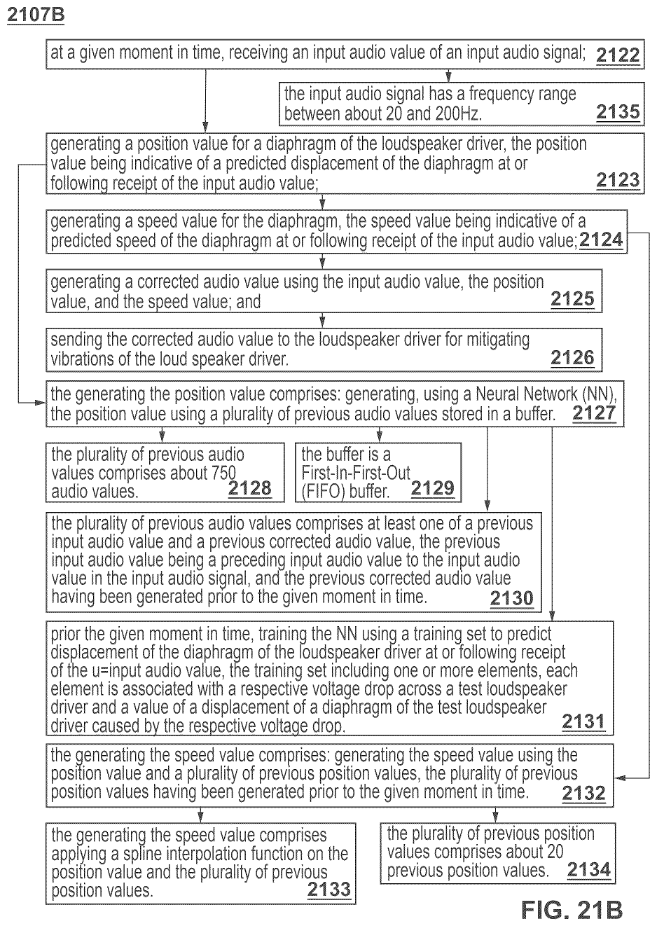

FIG. 21A illustrates a block-diagram of an embodiment of distortion compensation unit 2100. Input signal (Xᵢₙ) 2101 is split into two parts by crossover 2102: lower input signal (bass) 2103 and upper input signal (treble) 2104. This may be achieved by applying a low-pass filter to input signal 2101, with the upper frequency of the low-pass filter defined by the loudspeaker. For example, in one embodiment of loudspeaker driver 118, the upper frequency of the low-pass filter may be set to 150 Hz. Low input signal (bass) 2103 may required pre-distortion. Application of pre-distortion to treble 2104 may not provide a noticeable quality improvement in output sound 122. Therefore, compensation for nonlinear sound distortion may need to be applied only to lower input signal 2103. Such an approach may reduce the computational load on the processor.

Treble signal 2104 may be generated by passing input signal 2101 through a high-pass filter. Crossover 2102 ensures that lower input signal (bass) 2103 and upper input signal (treble) 210 are continuously linked. It should be noted, that in the present disclosure the term “crossover” is used to identify a device, for example, an of electronic filter, splitting an audio signal into two or more frequency ranges, so that the signals may be sent to loudspeaker drivers that are designed to operate within different frequency ranges.

Treble signal 2104 may be inputted to combiner 2105 unchanged and with a delay equal to a group delay of a lower input signal 2103 path (The delay may be implemented by delay block 2106. In the instant disclosure the term “delay block” is used to identify a device providing a group delay to an input electric signal.).

Bass signal 2103 may be inputted to decimator 2109 wherein bass signal 2103 may be sampled at 4 kHz. In this disclosure the term “decimator” is used to identify a device downsampling an input electric signal, for example, bass signal 2103. This action is necessary to ensure proper operation of position and speed estimator 2108 of predistortion core 2107. Predistortion core 2107 may be, for example, a processor or a plurality of processors configured to generate a position value together with a speed value of diaphragm 212 of loudspeaker driver 118, and use the position value, the speed value, and a value of the input audio signal to generate a corrected audio signal with a corrected audio value. Output digital signal 2111 of decimator 2109 (e.g., with the ranges between −1 and +1) is inputted to and multiplied by multiplier 2110. (In the instant disclosure, the term “multiplier” or “frequency mixer” is used to identify a device that creates new frequencies from two signals applied to it.) Input audio signal (Vᵢₙ) 2112 (with its respective input audio value) of multiplier 2110 is inputted to predistortion core 2107 as shown in FIG. 21A. Predistortion core 2107 may comprise model unit 2113. This unit may receive an input audio value of input audio signal (Vᵢₙ) 2112, as well as, position value (pos_est) 2114 and speed value (speed_est) 2115 for diaphragm 212 of loudspeaker driver 118. Model unit 2113 may use a nonlinear mathematical model of loudspeaker driver 118, for example, the model defined by Equation 3.14. The values of K_{speed}, and K_{stiffness} coefficients are defined by position value 2114 and speed value 2115. The parameters of the model may be also determined and/or pre-determined empirically as had been described above. Model unit 2113 may generate corrected audio signal (Vₒᵤₜ) 2116 (with respective corrected audio value). Vₒᵤₜ 2116 may be directed to loudspeaker driver 118 in stead of lower input signal 2103 of Xᵢₙ 2101. Each time the value of corrected audio signal (Vₒᵤₜ) 2116 is calculated, it may be stored in a memory, for example, in first-in, first-out (FIFO) buffer 2117. FIFO buffer 2117 may have a capacity to store 750 audio signal values, each sampled at 4 kHz. Position estimator 2108 may be connected to FIFO buffer 2117 and use one or more audio values in FIFO buffer 2117 to calculate position value 2114 (pos_est) and speed value 2115 (speed_est).

FIG. 21B illustrates method 2107B to generate corrected audio signal Vₒᵤₜ 2116 for loudspeaker driver 118. Method 2107B is provided according to embodiments of the present disclosure. Method 2107B is executable by predistortion core 2107 which may be implemented as one or more processors. At action 2122, predistortion core 2107, at a given moment in time, may receive an input audio value of input audio signal (Vin) 2112. At action 2123, predistortion core 2107 may generate position value (pos_est) 2114 for diaphragm 212 of loudspeaker driver 118, the position value being indicative of a predicted displacement of diaphragm 212 at or following receipt of the input audio value. At action 2124, predistortion core 2107 may generate speed value (speed_est) 2115, speed value 2115 being indicative of a predicted speed of diaphragm 212 at or following receipt of the input audio value. At action 2125, a corrected audio value may be generated by predistortion core 2107 using the input audio value of input audio signal Vin 2112, position value 2114, speed value 2115, or a combination thereof. At action 2126, corrected audio signal Vₒᵤₜ 2116 (with the corrected audio value) may be sent to loudspeaker driver 118 for mitigating vibrations of the loudspeaker driver. Action 2123 may include action 2127, wherein generating position value 2114 comprises using a Neural Network (NN) with a plurality of previous audio values (stored in a buffer) inputted to the NN. Action 2127 may include action 2128, wherein the plurality of previous audio values comprises about 750 audio values. Action 2127 may also include action 2129, wherein the buffer is First-In-First-Out (FIFO) buffer 2117. Action 2127 may also include action 2130, wherein the plurality of previous audio values comprises at least one of a previous input audio value and a previous corrected audio value, the previous input audio value being a preceding input audio value to the input audio value in the input audio signal, and the previous corrected audio value having been generated prior to the given moment in time. Action 2127 may include action 2131, wherein prior the given moment in time, the NN is trained using a training set to predict displacement of the diaphragm of the loudspeaker driver at or following receipt of the input audio value, the training set including one or more elements, each element is associated with a respective voltage drop across a test loudspeaker driver and a value of a displacement of a diaphragm of the test loudspeaker driver caused by the respective voltage drop. Action 2124 may include action 2132, wherein generating speed value 2115 comprises: generating the speed value using position value 2114 and a plurality of previous position values, the plurality of previous position values having been generated prior to the given moment in time. Action 2132 may include action 2133, wherein generating speed value 2115 comprises applying a spline interpolation function on the position value and the plurality of previous position values. Action 2132 may also include action 2134, wherein the plurality of previous position values comprises about 20 previous position values. Action 2122 may include action 2135, wherein the input audio signal has a frequency range between about 20 and 200 Hz.

Vₒᵤₜ 2116 may be scaled at multiplier 2118 to match the input range of up-sampler 2119. (In the instant disclosure, the term “up-sampler” is used to identify a devices operating to provide expansion and interpolation of an input electric signal. When the up-sampler is upsampling the sequence of samples of the input electric signal, it produces an approximation of the sequence that would have been obtained by sampling the signal at a higher rate.) Up-sampler 2119 may up-sample the signal to the original sampling frequency. Phase compensation filter 2120, which may be, for example, a finite impulse response (FIR) filter, compensates the up-sample signal for any phase shift introduced by multiplier 2118, multiplier 2110, predistortion core 2107, decimator 2109, upsampler 2119, or a combination thereof. The up-sample signal, after going through phase compensation filter 2120, may be inputted to combiner 2105 as shown in FIG. 21A. Responsive to input from phase compensation filter 2120 and delay block 2106, combiner 2105 may output signal (Yₒᵤₜ) 2121.

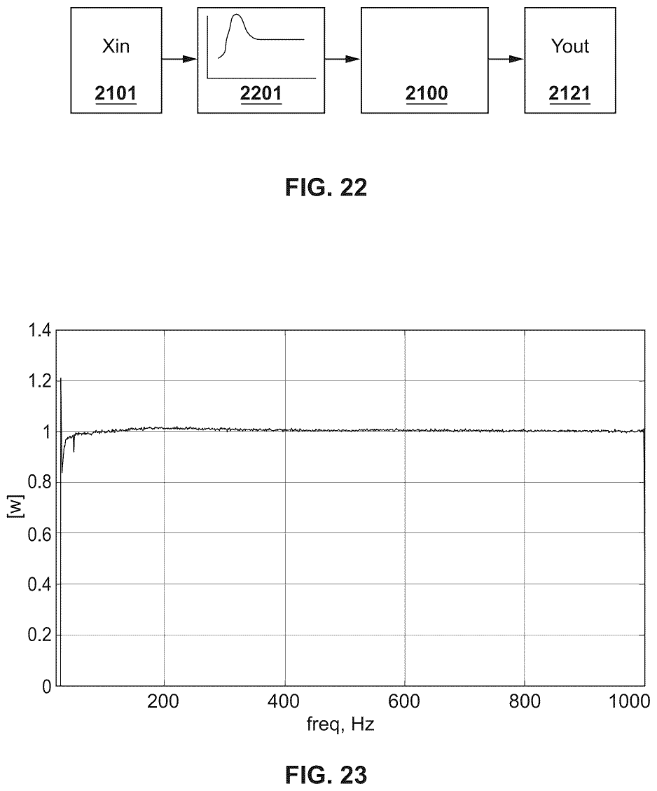

FIG. 22 illustrate another embodiment of distortion compensation unit 2100 with booster unit 2201. Booster unit 2201 boosts the low frequency part of input signal (Xᵢₙ) 2101.

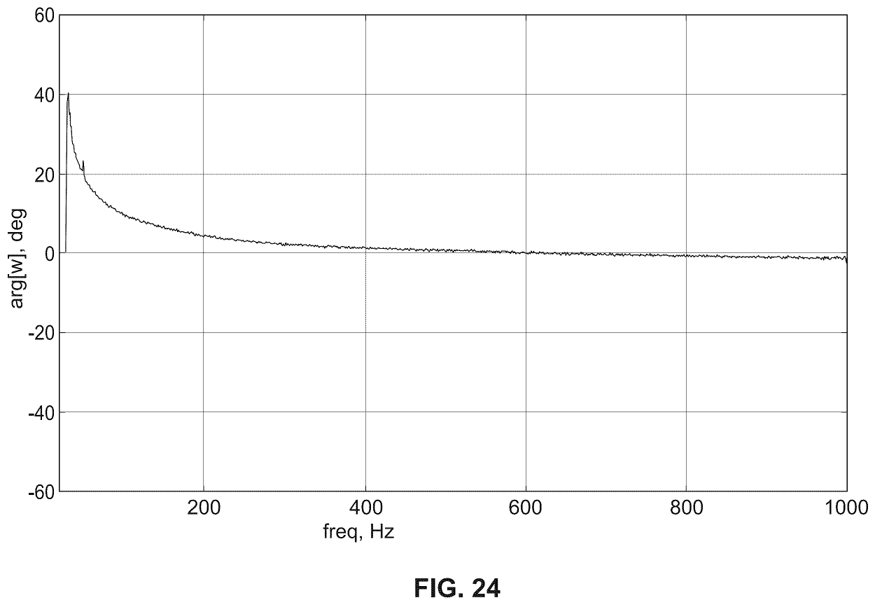

To compensate phase shift, introduced by an amplifier, amplifying output signal (Yₒᵤₜ) 2121, it may be necessary to evaluate its transfer function. FIG. 23 illustrates a gain response of the amplifier. Its phase transfer function is shown in FIG. 24. Even at relatively high frequency of 200 Hz, the phase shift is about 5 degrees, which may be unacceptable in some applications. Therefore, the pre-distorted signal obtained using equation (3.14) may have to be convoluted by a function inverse to the dependency shown in FIG. 24. After convolution, the pre-distorted waveform may be inputted to the loudspeaker driver.

Position estimator 2108 of distortion compensation unit 2100 may comprise a deep neural network (NN). In some embodiments position estimator 2108 may comprise a recurrent neural network (RNN) for predicting an instant position of diaphragm 212 of loudspeaker driver 118. The prediction may be based on previous measurements of the voltage drop across loudspeaker driver 118.

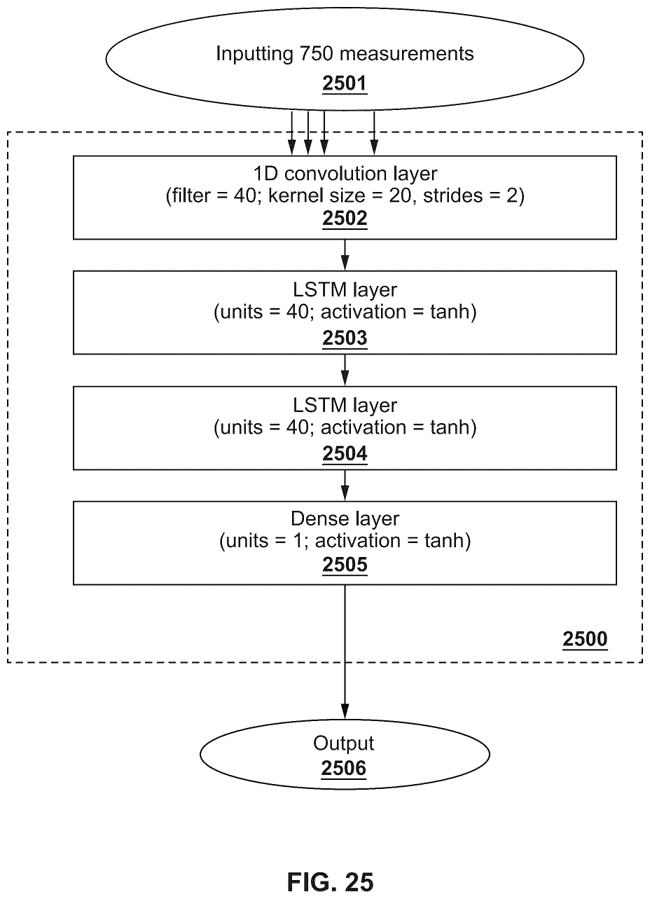

During the training stage, the NN of position estimator 2108 may be provided with empirical data as show in Table 1: a laser-detected displacement of diaphragm 212 of loudspeaker driver 118 and a respective drop of the voltage across loudspeaker driver 118. The voltage drop data is used as an input training set, the diaphragm displacement data is an output training set. The NN may use a sequence of 750 (for example) previous measurements of voltage drop across loudspeaker driver 118 (with time resolution between 150 and 190 ms). Following input of 750 previous measurements the NN of the position estimator 2108 may respond with an estimate of diaphragm position 2114. FIG. 25 illustrates architecture 2500 of an embodiment of the NN. Plurality of 750 measurements 2501 is inputted to 1D convolution layer 2502. 1D convolution layer 2502 may have the parameters: filter=40; kernel size=20, strides=2. The output of 1D convolution layer 2502 is inputted to LSTM layer 2503. The output of LSTM layer 2503 is inputted to LSTM layer 2504. LSTM layer 2503 and 2504 may have the following parameters: 40 unites, and hyperbolic tangent activation function. The output of LSTM layer 2504 is inputted to dense layer 2505 with the parameters: 1 unite, and hyperbolic tangent activation function. Dense layer 2505 outputs output 2506 comprising an estimate (a prediction) of a diaphragm displacement.

The trained NN of position estimator 2108 acts as “virtual” or neural feedback loop. The trained NN of position estimator 2108 may predict next displacement of diaphragm 212 based on the previously collected set of voltage drop across loudspeaker driver 118.

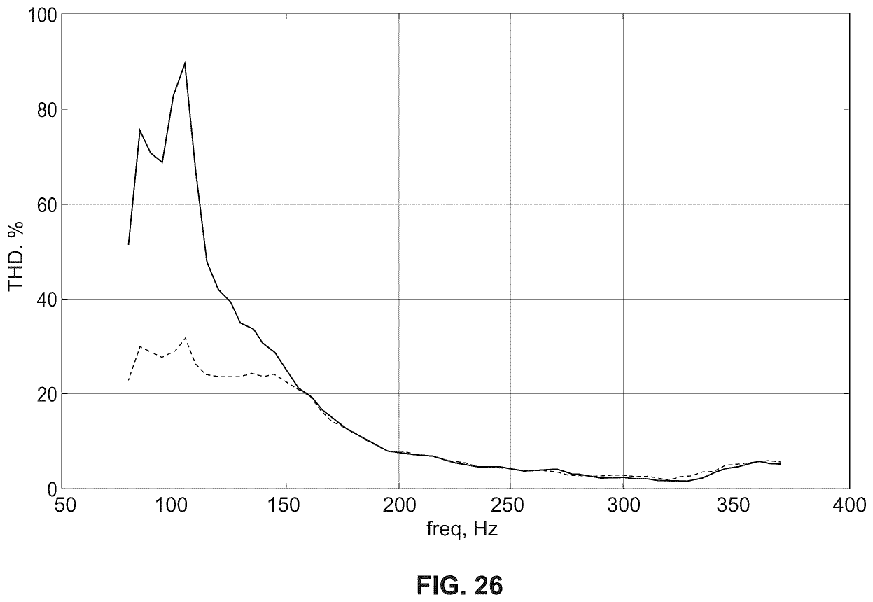

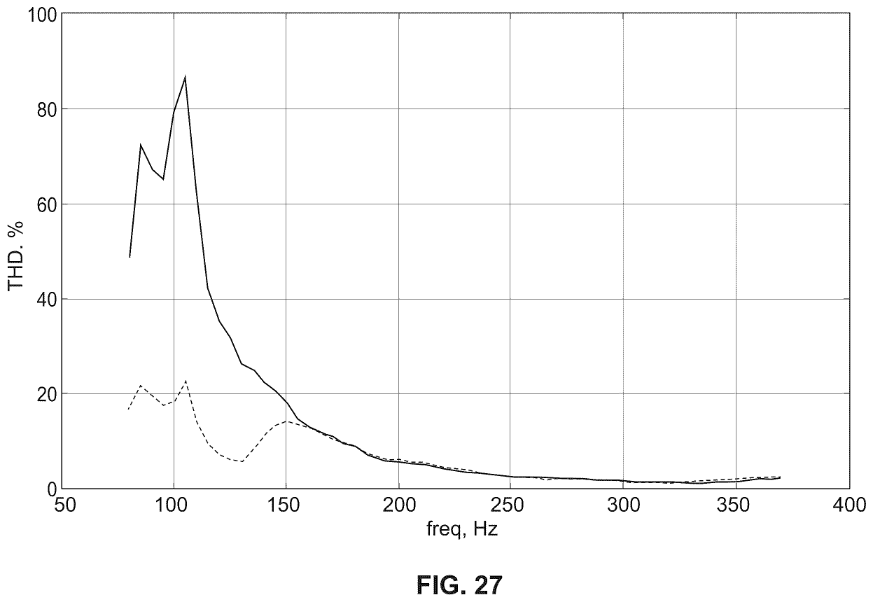

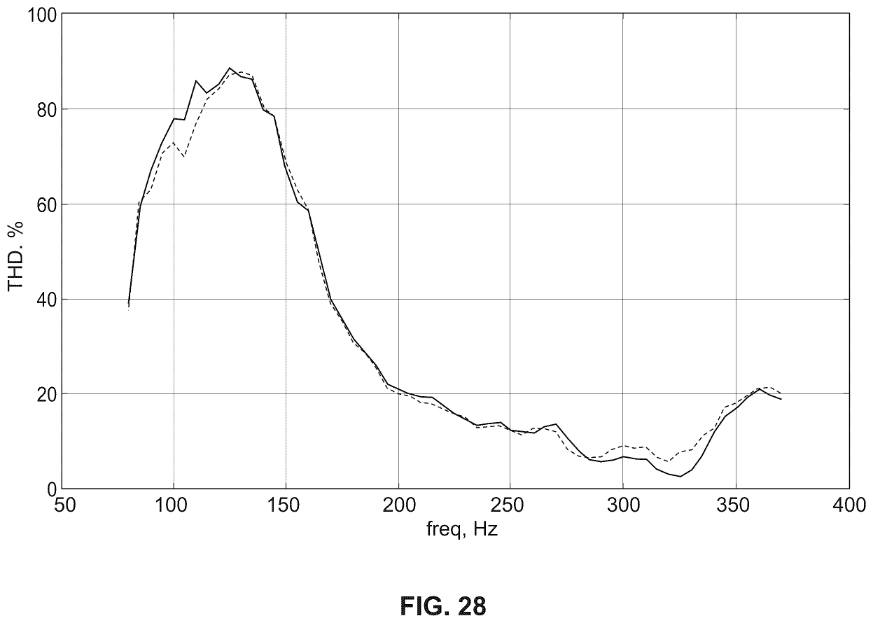

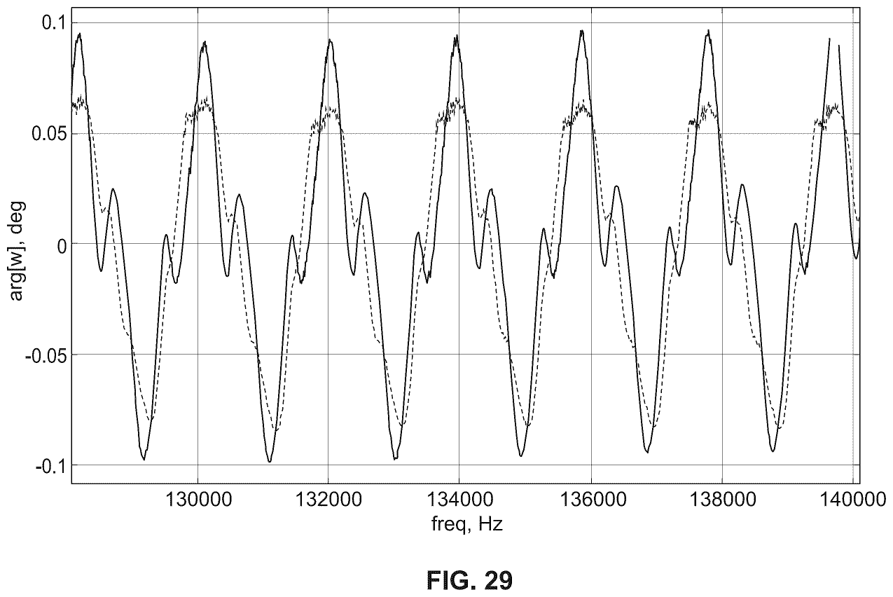

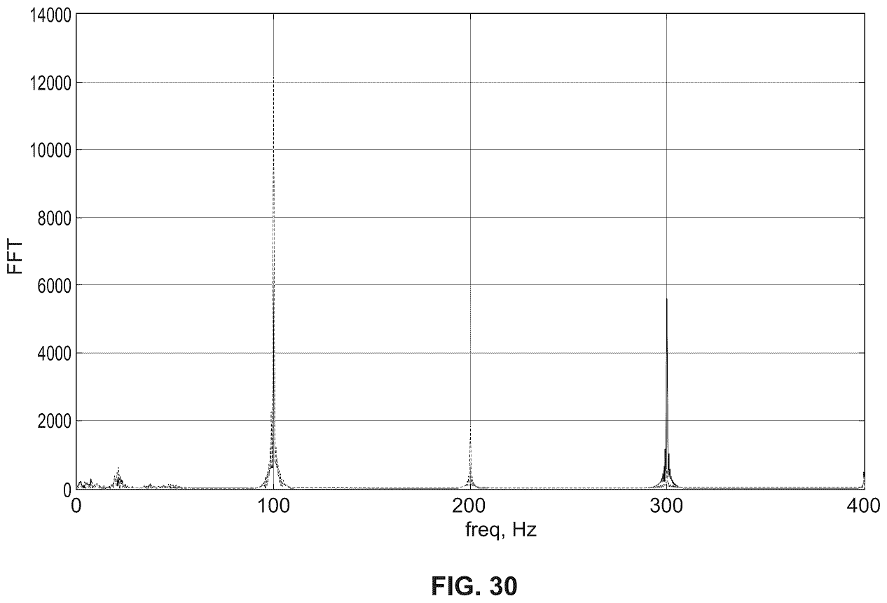

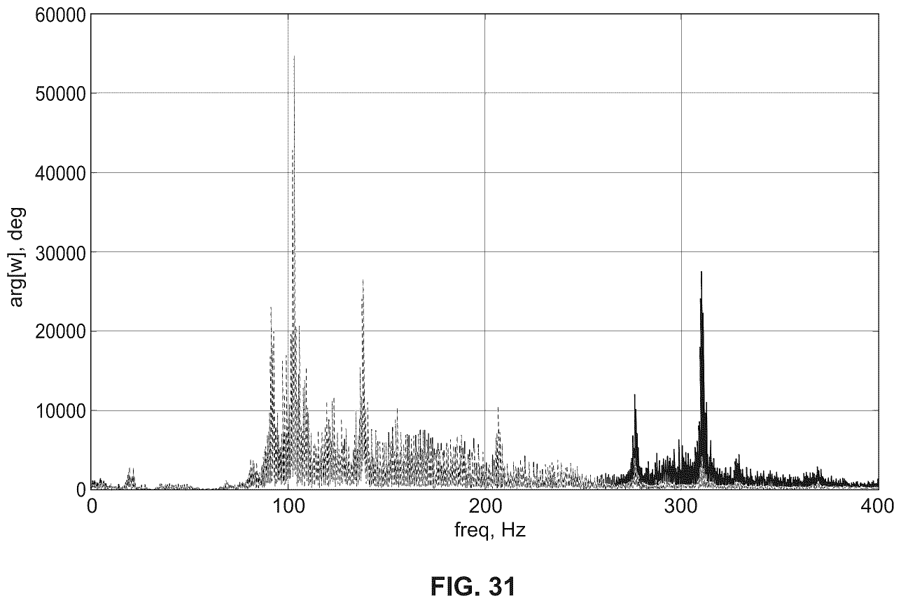

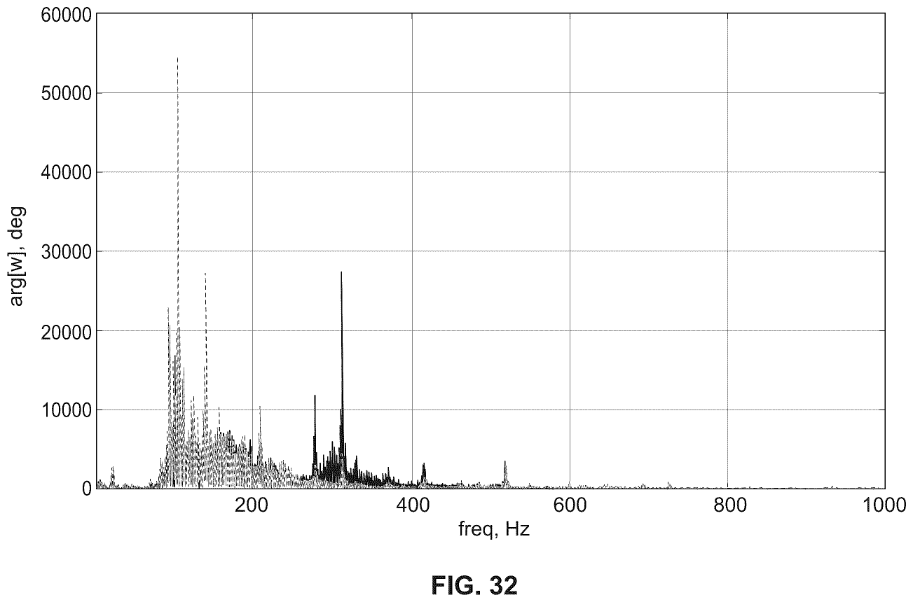

Application of disclosed embodiments of distortion compensation unit 2100 in loudspeakers may allow to achieve the level of sound distortion suppression as shown in FIG. 26. Herein before amplification the input audio signal was subjected to nonlinear mathematical processing in distortion compensation unit 2100. FIG. 26 illustrates that without processing in distortion compensation unit 2100 (the solid line) at frequencies below 150 Hz total harmonic distortion (THD) level of the output sound signal was more than 25%, with a peak value of 89% at 105 Hz. After the input audio signal was processed in distortion compensation unit 2100 (the dashed line) the THD level of the output sound signal fell down to 32% and less. Application of the disclosed technology (distortion compensation unit 2100) reduces the THD level by 2.8 times (at 100 Hz) while the volume of playback remains at the same level. Reduction of the THD level in the output sound signal is mainly achieved by mitigating the third harmonic. Typically, when a simple sinusoidal voltage is applied to a loudspeaker, the third harmonic in the generated sound has the highest amplitude. In extreme cases, the amplitude of the third harmonic may even exceed the amplitude of the fundamental tone. FIG. 27 illustrates the amplitude of the third harmonic (as a percentage of the amplitude of the fundamental tone) before (the solid line) and after (the dashed line) application of distortion compensation unit 2100. The graphs show that the disclosed technology is very effectively suppresses the third harmonic at frequencies below 150 Hz. The second harmonic also makes a significant contribution to the THD level of output sound. FIG. 28 illustrates the amplitude of the second harmonic (as a percentage of the amplitude of the fundamental tone) before (the solid line) and after (the dashed line) application of distortion compensation unit 2100. The graphs show that the developed technology is not efficient at mitigating the second harmonic. An improvement may be achieved if the amplifiers pass through a small DC component. Higher order harmonics have significantly smaller amplitudes in comparison to the amplitudes of the third and second harmonics. FIG. 29 compares the amplitude of the signal before (the solid line) and after (the dashed line) application of distortion compensation unit 2100 in the time domain. The treated signal (the dashed line) is much closer to a sinusoidal shape. FIG. 30 illustrates fast Fourier transform (FFT) of the signals before (the solid line) and after (the dashed line) application of distortion compensation unit 2100: the graphs show almost complete suppression of the third harmonic. FIGS. 31 and 32 illustrate evaluation of distortion compensation unit 2100 using the input audio signal with limited frequency spectrum between 20 and 200 Hz. The audio signal was put through the low-pass filter. The disclosed method effectively suppresses harmonics of bass tones in the range from 200 to 500 Hz as illustrated in FIGS. 31-32. The difference between not treated (the solid line) and treated (the dashed line) output sound signals becomes noticeable to a listener if the frequency range from 250 to 500 Hz is selected.

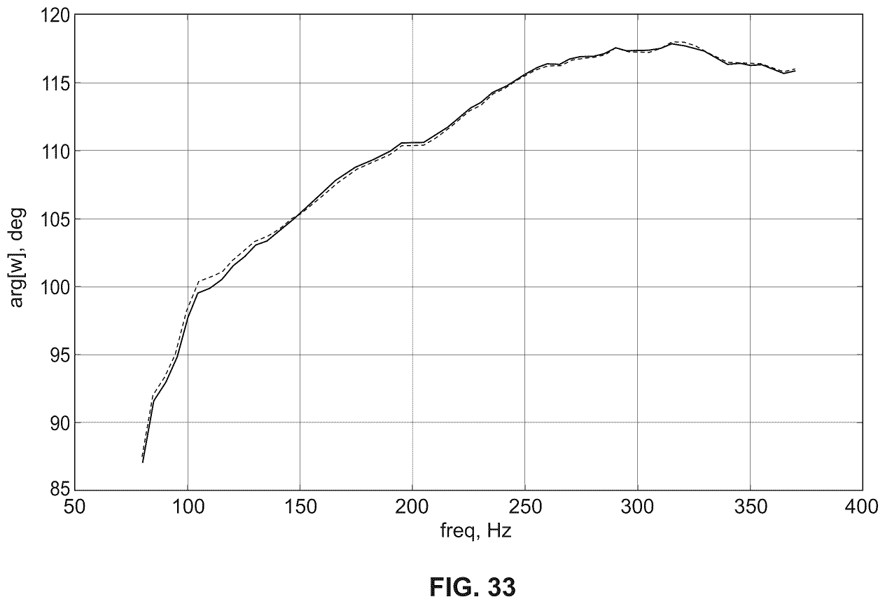

FIG. 33 illustrates the sound pressure level (SPL) dB of the fundamental tone before (the solid line) and after (the dashed line) application of the technology.

The foregoing description is intended to be exemplary rather than limiting. Although the present invention has been described with reference to specific features and embodiments thereof, it is evident that various modifications and combinations can be made thereto without departing from the invention. Accordingly, the specification and drawings should be regarded as an illustration of the invention as defined by the appended claims, and are contemplated to cover any and all modifications, variations, combinations or equivalents that fall within the scope of the present invention.

What is claimed is:

1. A method for generating a corrected audio value for a loudspeaker driver, the method executable by one or more processors, the method comprising:
at a given moment in time:
receiving an input audio value of an input audio signal;
generating a position value for a diaphragm of the loudspeaker driver, the position value being indicative of a predicted displacement of the diaphragm at or following receipt of the input audio value;
generating a speed value for the diaphragm, the speed value being indicative of a predicted speed of the diaphragm at or following receipt of the input audio value;
generating a corrected audio value using the input audio value, the position value, and the speed value; and
sending the corrected audio value to the loudspeaker driver for mitigating vibrations of the loudspeaker driver.

2. The method of claim 1, wherein the generating the position value comprises:
generating, using a Neural Network (NN), the position value using a plurality of previous audio values stored in a buffer.

3. The method of claim 2, wherein the method further comprises:
prior the given moment in time, training the NN using a training set to predict displacement of the diaphragm of the loudspeaker driver at or following receipt of the input audio value,
the training set including one or more elements, each element is associated with a respective voltage drop across a test loudspeaker driver and a value of a displacement of a diaphragm of the test loudspeaker driver caused by the respective voltage drop.

4. The method of claim 2, wherein the plurality of previous audio values comprises at least one of a previous input audio value and a previous corrected audio value, the previous input audio value being a preceding input audio value to the input audio value in the input audio signal, and the previous corrected audio value having been generated prior to the given moment in time.

5. The method of claim 2, wherein the plurality of previous audio values comprises about 750 audio values.

6. The method of claim 2, wherein the buffer is a First-In-First-Out (FIFO) buffer.

7. The method of claim 1, wherein the generating the speed value comprises:
generating the speed value using the position value and a plurality of previous position values, the plurality of previous position values having been generated prior to the given moment in time.

8. The method of claim 7, wherein the generating the speed value comprises applying a spline interpolation function on the position value and the plurality of previous position values.

9. The method of claim 7, wherein the plurality of previous position values comprises about 20 previous position values.

10. The method of claim 1, wherein the input audio signal has a frequency range between about 20 and 200 Hz.

11. A processor for generating a corrected audio value for a loudspeaker driver, the processor is configured to:
at a given moment in time:
receive an input audio value of an input audio signal;
generate a position value for a diaphragm of the loudspeaker driver, the position value being indicative of a predicted displacement of the diaphragm at or following receipt of the input audio value;
generate a speed value for the diaphragm, the speed value being indicative of a predicted speed of the diaphragm at or following receipt of the input audio value;
generate a corrected audio value using the input audio value, the position value, and the speed value; and
send the corrected audio value to the loudspeaker driver for mitigating vibrations of the loudspeaker driver.

12. The processor of claim 11, wherein the position value being generated using a plurality of previous audio values stored in a buffer, the plurality of previous audio values being inputted to a Neural Network (NN).

13. The processor of claim 12, wherein, prior the given moment in time, the NN having been trained using a training set to predict displacement of the diaphragm of the loudspeaker driver at or following receipt of the input audio value, the training set including one or more elements, each element is associated with a respective voltage drop across a test loudspeaker driver and a value of a displacement of a diaphragm of the test loudspeaker driver caused by the respective voltage drop.

14. The processor of claim 12, wherein the plurality of previous audio values comprises at least one of a previous input audio value and a previous corrected audio value, the previous input audio value being a preceding input audio value to the input audio value in the input audio signal, and the previous corrected audio value having been generated prior to the given moment in time.

15. The processor of claim 12, wherein the plurality of previous audio values comprises about 750 audio values.

16. The processor of claim 12, wherein the buffer is a First-In-First-Out (FIFO) buffer.

17. The processor of claim 11, wherein the speed value being based on the position value and a plurality of previous position values, the plurality of previous position values having been generated prior to the given moment in time.

18. The processor of claim 17, wherein the speed value being generated by applying a spline interpolation function on the position value and the plurality of previous position values.

19. The processor of claim 17, wherein the plurality of previous position values comprises about 20 previous position values.

20. The processor of claim 11, wherein the input audio signal has a frequency range between about 20 and 200 Hz.
